(19) United States
(12) Patent Application Publication
(10) Pub. No.: US 2015/0088528 A1
(43) Pub. Date: Mar. 26, 2015

(54) DECODING APPARATUS AND METHOD, AUDIO SIGNAL PROCESSING APPARATUS AND METHOD, AND PROGRAM

(71) Applicant: Sony Corporation, Tokyo (JP)

(72) Inventors: Yasuhiro Toguri, Kanagawa (JP); Yuuji Maeda, Tokyo (JP); Jun Matsumoto, Kanagawa (JP)

(21) Appl. No.: 14/390,810

(22) PCT Filed: Apr. 4, 2013
(86) PCT No.: PCT/JP2013/060363

§ 371 Date: Oct. 6, 2014

(30) Foreign Application Priority Data
Apr. 13, 2012 (JP) 2012-091823
Jun. 22, 2012 (JP) 2012-140462

(51) Int. Cl. G10L 19/005

(52) U.S. Cl. CPC G10L 19/005
USPC 704/500

(57) ABSTRACT

The present technique relates to a decoding apparatus and method, an audio signal processing apparatus and method, and a program that enable generation of an interpolation signal with less incongruity through a smaller amount of calculation.

A frame signal decoding unit generates a decoded signal by decoding frame data, and an interpolation state determining unit determines an interpolation status for specifying the pattern of the process to be performed to obtain an output signal based on an error flag. A similar signal detecting unit extracts part of a thinned signal obtained by thinning a past output signal. An upsampling unit upsamples the extracted thinning signal, and a smoothing unit generates an interpolation signal by performing a smoothing process on the upsampled thinned signal. An output switching unit outputs an output signal that is a decoded signal, an interpolation signal, or a signal obtained by subjecting the decoded signal and the interpolation signal to a weighted overlap addition, depending on the interpolation status. The present technique can be applied to audio signal processing apparatuses.

### TECHNICAL FIELD

The present technique relates to decoding apparatuses and methods, audio signal processing apparatuses and methods, and programs, and more particularly, to a decoding apparatus and method, an audio signal processing apparatus and method, and a program that are suitably used in encoding or decoding audio signals.

### BACKGROUND ART

In conventional audio encoding apparatuses, an encoding apparatus that performs orthogonal transform by overlapping the audio signals of adjacent blocks as in MDCT (Modified Discrete Cosine Transform) and then encodes the audio signals is often used.

A packet of data encoded by such an encoding apparatus is transmitted. If the packet disappears during transmission, or if there is a data error, not only the frame with the data error but also the next frame cannot be correctly decoded, and acoustic quality becomes much lower due to intermittent sound or the like. So as to prevent such a problem, when a packet has disappeared or an error has occurred during decoding, it is necessary to generate an interpolation signal that interpolates the missing frame signal to compensate for the error portion.

An interpolation signal can be generated by substituting the error portion with silence or noise, by using the previous frame data, by substituting the error portion with a past similar waveform (WS (Waveform Substitution) method), or by iterating a pitch waveform (PWS (Pitch Waveform Substitution) method), for example.

The waveform substitution method (WS method) and the pitch waveform substitution method (PWS method) are disclosed in detail in Non-Patent Document 1 and Non-Patent Document 2, for example.

There is also a suggested method of switching high-frequency component interpolation between interpolation based on pitch iterations and interpolation by a repetition of the previous frame in accordance with the periodic intensity (see Patent Document 1, for example).

### CITATION LIST

### Non-Patent Document

Non-Patent Document 1: D. J. Goodman, et al, “Waveform Substitution Techniques for Recovering Missing Speech Segments in Packet Voice Communications”, IEEE Transactions on Acoustics, Speech, and Signal Processing, ASSP-34 No. 6 1440-1448 (1986)
Non-Patent Document 2: O. J. Wasem et al., “The effect of waveform substitution on the quality of PCM packet communications” IEEE Trans. Acoustics, Speech, and Sig. Processing, vol. 36, no. 3, 31988, pp. 342-48

### Patent Document

Patent Document 1: JP 4603091 B1

### SUMMARY OF THE INVENTION

### Problems to be Solved by the Invention

However, a large memory and a large amount of calculation are required to generate an interpolation signal by determining a pitch cycle according to the above mentioned method. Particularly, when the sampling frequency is high, the number of samples corresponding to a predicted range of pitch cycles varies over a wide range, and the buffer size and the amount of calculation for determining a pitch cycle become larger. Therefore, there is a demand for a method of obtaining an interpolation signal with less incongruity through a small amount of calculation.

At a broadcast station or the like, multichannel audio signals need to be encoded and decoded, and the channel configuration needs to be promptly changed. However, in a case where static data regions of audio signal encoding and decoding apparatuses compatible with the respective channels are dynamically secured, the once secured static data regions need to be released when the channel settings are changed, and new static memory regions need to be secured. In the worst case scenario, data fragmentation might be caused.

Also, audio signals need to be synchronized with other signals such as video (image) signals. Therefore, if the channel settings are changed while synchronization is established, the apparatus might become unstable.

Further, as audio signals are synchronized with other signals such as image signals, an external synchronization signal needs to be supplied to the signal processing apparatus in a frame cycle formed with a predetermined number of samples of the audio signal encoding and decoding apparatuses. Therefore, so as to capture audio signals in synchronization with the external synchronization signal, a check may be made to determine whether the external synchronization signal is received when transmission/reception of the respective samples of audio signals is interrupted. However, this method requires an excessively large load. Therefore, sound and audio signals are transmitted and received with a ring buffer, and audio signals are captured when the external synchronization signal is received. In doing so, however, management of the pointer for audio signal transmission/reception becomes complicated.

The present technique has been developed in view of those circumstances, and aims to enable generation of an interpolation signal with less incongruity through a smaller amount of calculation. The present technique also aims to enable encoding and decoding of audio signals that are synchronized with other signals in a simpler manner.

### Solutions to Problems

A decoding apparatus of a first aspect of the present technique includes: a decoding unit that generates a decoded signal by decoding an audio signal on a frame basis; a thinning unit that generates a thinned signal by performing a thinning process on an output signal that is output earlier; an interpolation signal generating unit that generates an interpolation signal based on the thinned signal; and an output switching unit that outputs the decoded signal or the interpolation signal as the output signal in accordance with error information about the frame.

The thinning unit may perform the thinning process directly on the output signal, to generate the thinned signal into which a high-frequency foldback component of the output signal is mixed.

The decoding apparatus may further include: a thinned signal storing unit that stores the thinned signal; and a similar signal detecting unit that detects a similar zone that is similar to the zone of the thinned signal of the time immediately before the audio signal having disappeared among the thinned signals stored in the thinned signal storing unit when the audio signal has disappeared from the frame being processed. The interpolation signal generating unit may generate the interpolation signal based on the signal in the zone immediately after the similar zone among the thinned signals stored in the thinned signal storing unit.

The interpolation signal generating unit may upsample the signal in the zone immediately after the similar zone among the thinned signals stored in the thinned signal storing unit, and the decoding apparatus may further include a smoothing unit that performs a filtering process using a low-pass filter on the signal upsampled by the interpolation signal generating unit, and sets the filtered signal as the interpolation signal.

The smoothing unit may use the audio signal immediately before the audio signal having disappeared from the frame being processed, or the signal obtained by upsampling the thinned signal of the time immediately before the audio signal having disappeared, as the initial value of the internal state of the low-pass filter.

The thinning unit may generate the thinned signal by performing the thinning process on the decoded signal or the interpolation signal, whichever is output as the output signal from the output switching unit.

The decoding apparatus may further include an interpolation state determining unit that determines an interpolation status based on the error information about the frame. The output switching unit may generate a combined signal by performing a weighted overlap addition on the interpolation signal and the decoded signal, and output the decoded signal, the interpolation signal, or the combined signal as the output signal in accordance with the interpolation status.

A decoding method or a program of the first aspect of the present technique includes the steps of: generating a decoded signal by decoding an audio signal on a frame basis; generating a thinned signal by performing a thinning process on an output signal that is output earlier; generating an interpolation signal based on the thinned signal; and outputting the decoded signal or the interpolation signal as the output signal in accordance with error information about the frame.

In the first aspect of the present technique, a decoded signal is generated by decoding an audio signal on a frame basis, a thinned signal is generated by performing a thinning process on an output signal that is output earlier, an interpolation signal is generated based on the thinned signal, and the decoded signal or the interpolation signal is output as the output signal in accordance with error information about the frame.

An audio signal processing apparatus of a second aspect of the present technique includes: a timing signal generating unit that outputs an internal timing signal when a double buffer is switched while an audio signal is processed by using the double buffer formed with two buffers each having a predetermined length; and a synchronization control unit that synchronizes the internal timing signal with an external timing signal supplied from the outside when the internal timing signal and the external timing signal are not in synchronization, by shortening the duration of time before the switching in the double buffer by the amount equivalent to the phase difference between the internal timing signal and the external timing signal.

The audio signal processing apparatus may further include a state changing unit that changes the current state to a synchronization complete state and continues the processing of the audio signal using the double buffer when the internal timing signal and the external timing signal are in synchronization, and changes the current state to a synchronization incomplete state and suspends the processing of the audio signal when the internal timing signal and the external timing signal are not in synchronization.

When processing of the audio signals of channels is controlled and there is a request for a change of the number of channels of the audio signals to be processed, the state changing unit may change the current state to the synchronization incomplete state, and suspend the processing of the audio signal.

The synchronization control unit may synchronize the internal timing signal with the external timing signal by shortening the length of one buffer in the double buffer by the amount equivalent to the phase difference and shortening the duration of time before the switching in the double buffer, and return the duration of time before the next switching in the double buffer to the original unshortened length by returning the shortened length of the buffer to the original length.

The timing signal generating unit may switch the double buffer and output the internal timing signal when the audio signal received is stored into one of the buffers constituting the double buffer and the storing of the audio signal into the one of the buffers is completed. The state changing unit may control encoding of the audio signal depending on whether the current state is the synchronization complete state or is the synchronization incomplete state. The audio signal processing apparatus may further include an encoding unit that encodes the audio signal stored in the other one of the buffers constituting the double buffer when the current state is the synchronization complete state.

The timing signal generating unit may switch the double buffer and output the internal timing signal when the audio signal decoded and stored in one of the buffers constituting the double buffer is transmitted and the transmission of the audio signal from the one of the buffers is completed. The state changing unit may control decoding of the audio signal depending on whether the current state is the synchronization complete state or is the synchronization incomplete state. The audio signal processing apparatus may further include a decoding unit that decodes the audio signal and stores the decoded audio signal into the other one of the buffers constituting the double buffer when the current state is the synchronization complete state.

A recording region of a size determined by the largest possible number of channels of the audio signal to be processed may be secured as a static data storage region for storing information necessary for processing the audio signal of each channel, and static data regions of the respective channels for storing the information necessary for processing the audio signal may be secured in the static data storage region when there is a request for a change of the number of channels.

An audio signal processing method or a program of the second aspect of the present technique includes the steps of: outputting an internal timing signal when a double buffer is switched while an audio signal is processed by using the double buffer formed with two buffers each having a predetermined length; and synchronizing the internal timing signal with an external timing signal supplied from the outside when the internal timing signal and the external timing signal are not in synchronization, by shortening the duration of time before the switching in the double buffer by the amount equivalent to the phase difference between the internal timing signal and the external timing signal.

In the second aspect of the present technique, an internal timing signal is output when a double buffer is switched while an audio signal is processed by using the double buffer formed with two buffers each having a predetermined length, and the internal timing signal is synchronized with an external timing signal supplied from the outside when the internal timing signal and the external timing signal are not in synchronization, by shortening the duration of time before the switching in the double buffer by the amount equivalent to the phase difference between the internal timing signal and the external timing signal.

### Effects of the Invention

According to the first aspect of the present technique, an interpolation signal with less incongruity can be obtained through a smaller amount of calculation. According to the second aspect of the present technique, encoding or decoding can be performed on audio signals that are synchronized with other signals in a simpler manner.

### BRIEF DESCRIPTION OF DRAWINGS

FIG. 1 is a diagram showing an example structure of an audio signal processing apparatus.

FIG. 2 is a diagram for explaining interpolation statuses and processing patterns.

FIG. 3 is a diagram for explaining interpolation status transitions.

FIG. 4 is a diagram showing an example inner structure of the output switching unit.

FIG. 5 is a diagram showing an example weight.

FIG. 6 is a flowchart for explaining a decoding process.

FIG. 7 is a diagram for explaining the effects of foldback mixing and thinning.

FIG. 8 is a diagram for explaining generation of an interpolation signal.

FIG. 9 is a diagram showing an example structure of an audio signal processing apparatus.

FIG. 10 is a diagram for explaining audio signal frame synchronization.

FIG. 11 is a diagram for explaining maintenance of static data regions of respective channels.

FIG. 12 is a diagram for explaining synchronization state transitions.

FIG. 13 is a flowchart for explaining an encoding/decoding process.

FIG. 14 is a diagram showing an example structure of a computer.

### MODES FOR CARRYING OUT THE INVENTION

The following is a description of embodiments to which the present technique is applied, with reference to the drawings.

### First Embodiment

### Features of the Present Technique

First, the features of the present technique to be shown as a first embodiment are described.

The present technique is to readily obtain an interpolation signal (a substitute signal) with less incongruity through a smaller amount of calculation in a case where an error occurs due to a transmission packet disappearance when encoded audio data (an audio signal) is decoded. Particularly, the present technique has the following features (1) through (7).

(1)

A method and an apparatus for interpolating an audio signal by thinning and storing the frame data of an input signal, and generating an interpolation signal for a missing frame based on past thinning data when a frame disappears.

(2)

In (1), when the frame data is thinned, the thinning process is performed without the use of a high-frequency suppression filter, to mix a high-frequency foldback component into the signal.

(3)

In (1) and (2), the interpolation signal is generated by storing thinned frame signals into a buffer, searching the buffer for a portion similar to the thinned signal located immediately before a frame data disappearance in the buffer when the disappearance occurs, upsampling the thinned signal located immediately behind the similar portion, and performing smoothing with the use of a low-pass filter.

(4)

In (3), when a low-pass filter is applied to an upsampled signal, the signal sample located immediately before the missing frame or the signal obtained by upsampling the thinned signal located immediately before the missing frame is used as the initial value of the internal state of the filter.

(5)

In (1) through (4), an interpolation signal generated by an interpolating process is subjected to a thinning process for generating an interpolation signal, and is stored into a buffer.

(6)

The interpolating apparatus of (1) through (5) is a decoding apparatus that decodes encoded data, and generates an output by performing a weighted overlap addition on the decoded signal and an interpolation signal generated by an interpolating process by a predetermined number of samples counted from the top of the frame.

(7)

In (1) through (6), a state variable having an interpolation status is provided, and whether to perform the similar portion detection and the weighted overlap addition is determined based on the interpolation status.

### Structure of an Audio Signal Processing Apparatus

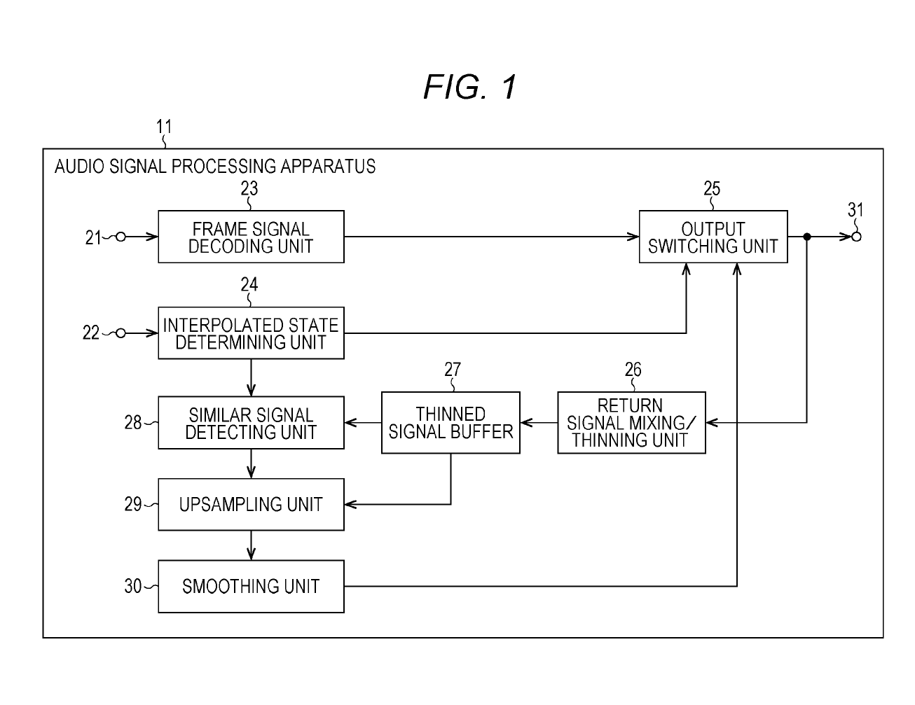

Next, an audio signal processing apparatus to which the present technique is applied is described. FIG. 1 is a diagram showing an example structure of an embodiment of an audio signal processing apparatus to which the present technique is applied.

The audio signal processing apparatus 11 shown in FIG. 1 includes an input terminal 21, an error flag input terminal 22, a frame signal decoding unit 23, an interpolation state determining unit 24, an output switching unit 25, a foldback mixing/thinning unit 26, a thinned signal buffer 27, a similar signal detecting unit 28, an upsampling unit 29, a smoothing unit 30, and an output terminal 31.

Specifically, the audio signal processing apparatus 11 includes the input terminal 21 that inputs encoded frame data, the error flag input terminal 22, the frame signal decoding unit 23 that decodes and converts frame data into a temporal signal sample, the interpolation state determining unit 24 that determines the interpolation status of the frame, the output switching unit 25 that combines and switches output frame data, the foldback mixing/thinning unit 26 that thins output signals and mixes a foldback signal therewith, the thinned signal buffer 27 that stores thinned signal samples, the similar signal detecting unit 28 that detects the optimum portion for generating an interpolation signal in the buffer, the upsampling unit 29 that generates intermediate interpolation signals by upsampling the signals in the detected portion, the smoothing unit 30 that performs smoothing on the upsampled signal so as to establish a smooth connection to the previous frame, and the output terminal 31 that outputs the temporal signal sample of the frame.

### Operation of the Audio Signal Processing Apparatus

Next, operation of the audio signal processing apparatus 11 is described.

Frame data that is encoded on a predetermined frame basis and is then transmitted is input to the input terminal 21, and is supplied to the frame signal decoding unit 23. For example, the frame data to be input to the input terminal 21 is the data of the respective frames of an audio signal that is encoded by a technique such as MDCT, which requires the current frame and the frame immediately before the current frame at the time of decoding of the current frame.

A frame error flag that indicates whether there is a missing frame is input to the error flag input terminal 22, and is supplied to the interpolation state determining unit 24.

In a case where frame data is correctly received, this error flag is “OFF (value 0)”. In a case where a packet does not arrive before a predetermined time due to an error or a delay during transmission, on the other hand, the frame data contained in the packet is considered to be missing, and the error flag is set at “ON (value 1)”.

When the error flag is “ON”, frame data is not input through the input terminal 21 (or dummy data is input).

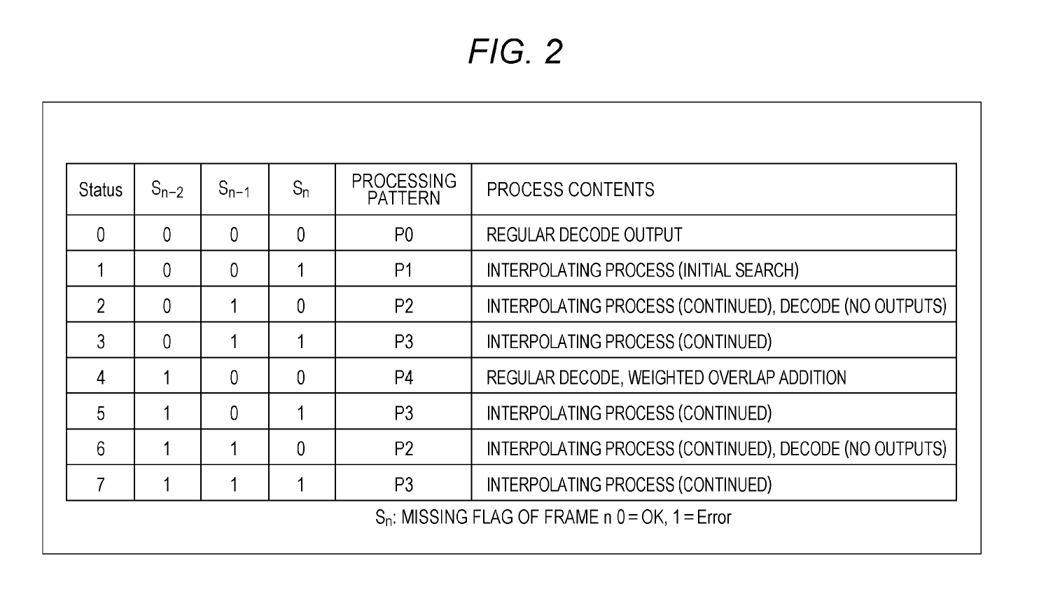

The interpolation state determining unit 24 determines an interpolating process status (an interpolation status) in accordance with the error flag that is input through the error flag input terminal 22. Operation of the apparatus varies with this status. FIG. 2 shows a list of processes corresponding to interpolation statuses.

FIG. 2 shows interpolation statuses “Status”, the respective error flags (missing flags) “Sₙ₋₂”, “Sₙ₋₁”, and “Sₙ” of a frame (n−2), a frame (n−1), and a frame n, processing patterns, and process contents.

Specifically, “Status” in FIG. 2 shows interpolation statuses for distinguishing states from one another, and the interpolation statuses include respective statuses “0” through “7”.

“Sₙ” indicates the value of the error flag of the nth frame or the frame n. Specifically, the value “0” (Sₙ=0) of the error flag indicates that the frame n is normal frame data, and the value “1” (Sₙ=1) of the error flag indicates that the frame n is a missing frame that has disappeared due to an error.

Likewise, “Sₙ₋₁” indicates the value of the error flag of the previous frame, or the error flag of the (n−1)th frame (n−1), and “Sₙ₋₂” indicates the value of the error flag of the one before the previous frame, or the error flag of the (n−2)th frame (n−2).

The processing patterns P0, P1, P2, P3, and P4 are the processing patterns corresponding to the respective interpolation statuses.

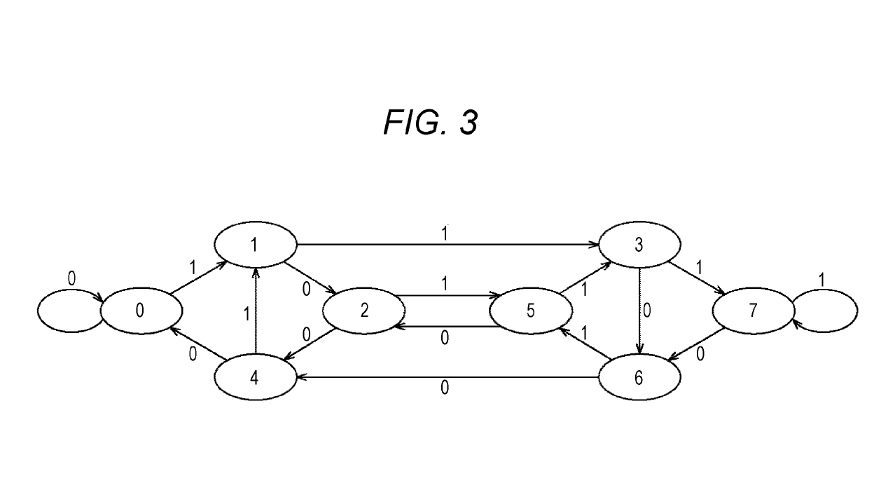

FIG. 3 is a state transition diagram of the interpolation statuses “Status” shown in FIG. 2. In FIG. 3, the numerical values shown in the respective ellipses represent the respective interpolation statuses. For example, the ellipse having the numerical value “0” represents the interpolation status “0”. The numerical values accompanying the arrows connecting the interpolation statuses indicate the values of the error flags.

For example, if normal frames successively appear until the (n−1)th frame, the interpolation status “Status” is “0”. If the nth frame disappears, and the error flag is switched to “ON”, the interpolation status “Status” is switched to “1”. If a normal frame is received as the next (n+1)th frame, the interpolation status “Status” is switched to “2”. If an error continues to occur, the interpolation status “Status” is switched to “3”.

In this manner, the interpolation status “Status” changes with the past error flag. As shown in FIG. 2, the process to be performed varies depending on the value of the interpolation status “Status”.

While the interpolation status “Status” is “0”, normal frames successively appear. In this case, only decoding processes are performed, and regular decoded signals are output. Such processes are the processing pattern “P0”.

When the interpolation status “Status” is “1”, an interpolation signal of a missing frame is generated after an initial search is conducted to search the buffer for the optimum portion for generating the interpolation signal. Such a process is the processing pattern “P1”. A case where the interpolation status “Status” is “1” is a case where the two frames immediately before the current frame are normal frames but a frame disappearance occurs in the current frame.

When the interpolation status “Status” is “2”, the above mentioned initial search is not conducted, but an interpolation signal continuing from the information used in the interpolating process performed on the previous frame is generated, and the frame received for the next frame is decoded (however, the decoded signal is not correct and therefore, is not to be output). Such a process is the processing pattern “P2”.

When the interpolation status “Status” is “3”, the above mentioned initial search is not conducted, and an interpolation signal continuing from the interpolating process performed on the previous frame is generated. Such a process is the processing pattern “P3”. In a case where a frame disappearance occurs in the frame before the current frame and an interpolation signal is generated as in a case where the interpolation status “Status” is “2” or “3”, the initial search is not conducted, and an interpolation signal is generated.

When the interpolation status “Status” is “4”, the received frame is decoded in a regular manner, and a connection with the interpolation signal of the frame immediately before the current frame is smoothly established. Accordingly, a weighted overlap addition (an overlap addition) is performed. Such a process is the processing pattern “P4”.

The process to be performed when the interpolation status “Status” is “5” or “7” is the process of the processing pattern “P3”, which is the same as the process to be performed when the interpolation status “Status” is “3”. The process to be performed when the interpolation status “Status” is “6” is the process of the processing pattern “P2”, which is the same as the process to be performed when the interpolation status “Status” is “2”.

Thereafter, the process to be performed varies with the interpolation status “Status”.

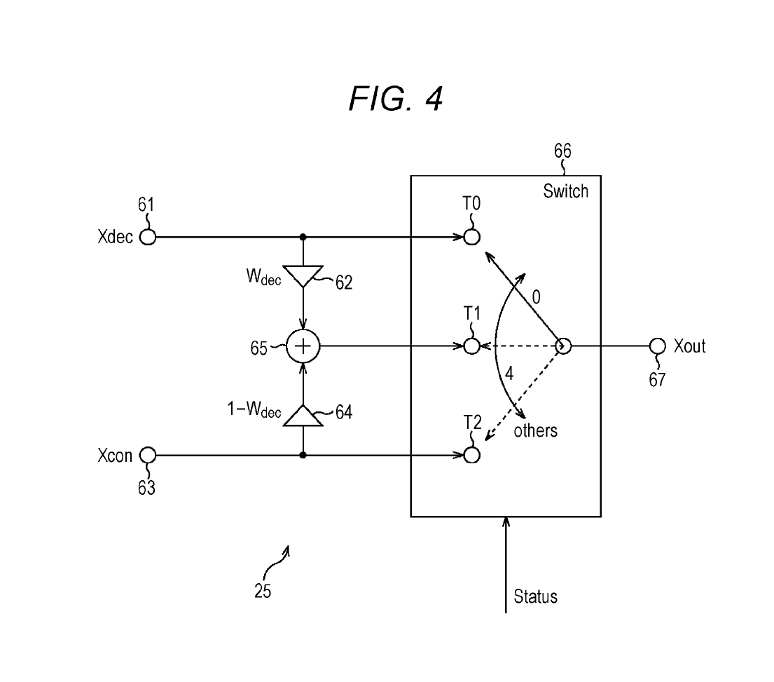

First, the output switching unit 25 is described. FIG. 4 is a diagram showing an example inner structure of the output switching unit 25.

The output switching unit 25 shown in FIG. 4 includes a terminal 61, a multiplier 62, a terminal 63, a multiplier 64, an adder 65, a switcher 66, and an output terminal 67. Terminals T0 through T2 are provided for the switcher 66, and the switcher 66 switches outputs by connecting the output terminal 67 to one of the terminals T0 through T2.

A decoded signal is supplied from the frame signal decoding unit 23 to the terminal 61, and this decoded signal is then supplied to the multiplier 62 and the terminal T0. The multiplier 62 multiplies the decoded signal from the terminal 61 by a weight W_{dec}, and then supplies the result to the adder 65.

An interpolation signal from the smoothing unit 30 is supplied to the terminal 63, and this interpolation signal is then supplied to the multiplier 64 and the terminal T2. The multiplier 64 multiplies the interpolation signal from the terminal 63 by a weight (1−W_{dec}), and then supplies the result to the adder 65.

The adder 65 adds the decoded signal from the multiplier 62 to the interpolation signal from the multiplier 64, and supplies the result to the terminal T1. Based on an interpolation status supplied from the interpolation state determining unit 24, the switcher 66 connects one of the terminals T0 through T2 to the output terminal 67.

Specifically, when the interpolation status “Status” is “0”, the terminal T0 is connected to the output terminal 67, and the decoded signal is output as it is to the output terminal 31.

When the interpolation status “Status” is “4”, the terminal T1 is connected to the output terminal 67, and the signal that has been subjected to the overlap addition and is output from the adder 65 is output to the output terminal 31. When the interpolation status “Status” is neither “0” nor “4”, the terminal T2 is connected to the output terminal 67, and the interpolation signal is output as it is to the output terminal 31.

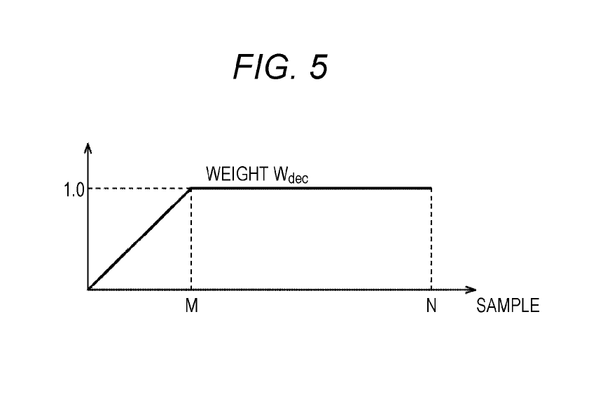

Here, the weight W_{dec} by which the decoded signal is multiplied at the multiplier 62 is the weight shown in FIG. 5, for example. In FIG. 5, the ordinate axis indicates the value of the weight W_{dec}, and the abscissa axis indicates decoded signal samples

In the example shown in FIG. 5, the decoded signal of one frame is formed with N samples, and the value of the weight W_{dec} by which each sample is to be multiplied becomes linearly larger from the first sample to the Mth sample of the decoded signal in this order timewise. The value of the weight W_{dec} of each sample after the Mth sample is 1.

Therefore, in a case where a decoded signal and an interpolation signal are subjected to a weighted overlap addition with a weight W_{dec}, the frame to be obtained as an output gradually changes from the interpolation signal to the decoded signal before the Mth sample, and thereafter, becomes the decoded signal. Through such a weighted overlap addition, a signal that transits smoothly from an interpolation signal to a decoded signal is obtained.

### Operation of the Audio Signal Processing Apparatus

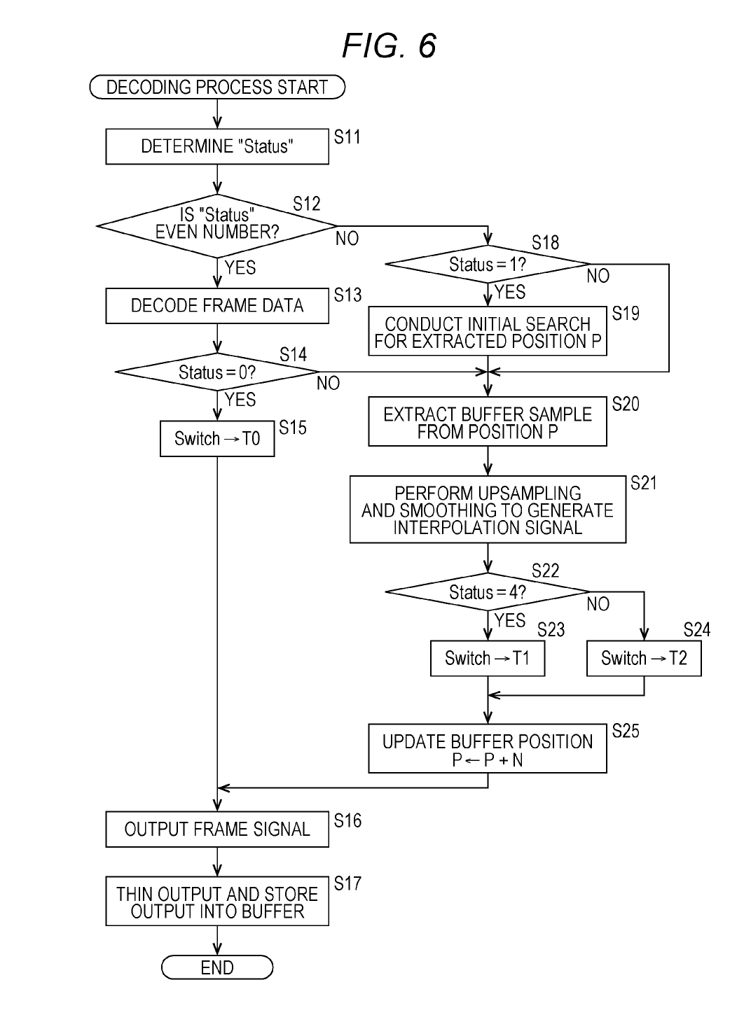

Referring now to the flowchart shown in FIG. 6, a decoding process to be performed by the audio signal processing apparatus 11 is described. It should be noted that this decoding process is performed every time the frame data of one frame is supplied to the audio signal processing apparatus 11.

In step S11, the interpolation state determining unit 24 determines the interpolation status “Status” based on error flags supplied from the error flag input terminal 22, and supplies a result of the determination to the switcher 66 of the output switching unit 25 and the similar signal detecting unit 28. For example, the interpolation status is determined based on the error flags Sₙ₋₂, Sₙ₋₁, and Sₙ, as shown in FIG. 2.

In step S12, the audio signal processing apparatus 11 determines whether the value of the interpolation status “Status” is an even number.

First, the process to be performed in a case where the interpolation status “Status” is “0” is described. Specifically, if the value of the interpolation status “Status” is determined to be an even number in step S12, the process moves on to step S13. If the value of the interpolation status “Status” is an even number, the error flag of the latest frame or the current frame to be processed is “0”, and therefore, frame data decoding is possible.

In step S13, the frame signal decoding unit 23 decodes frame data supplied from the input terminal 21, and supplies the resultant decoded signal to the terminal 61 of the output switching unit 25. At this point, using the frame immediately before the current frame, the frame signal decoding unit 23 decodes the frame data of the current frame supplied from the input terminal 21.

In step S14, the switcher 66 of the output switching unit 25 determines whether the value of the interpolation status “Status” supplied from the interpolation state determining unit 24 is “0”. If the value of the interpolation status “Status” is determined to be “0” in step S14, the process moves on to step S15.

In step S15, the switcher 66 of the output switching unit 25 switches the switch “Switch” to the terminal T0 on the decoded signal side. As a result, the terminal T0 is connected to the output terminal 67, and the decoded signal that is input from the frame signal decoding unit 23 to the terminal T0 via the terminal 61 is supplied as it is to the output terminal 31 via the output terminal 67. That is, the decoded signal becomes an output signal (a frame signal).

In step S16, the output terminal 31 outputs the frame signal (the decoded signal) supplied from the output terminal 67 of the output switching unit 25, as an output signal, to an apparatus in a later stage. The output signal that is output from the output terminal 67 is also supplied to the foldback mixing/thinning unit 26.

In step S17, the foldback mixing/thinning unit 26 performs downsampling by thinning the frame signal (the output signal) supplied from the output switching unit 25 on a predetermined sample unit basis (by the sample unit of 2, 4, or 8, for example), and supplies and stores the resultant thinned signal into the thinned signal buffer 27.

In this case, low-pass filtering that is normally performed to prevent aliasing prior to thinning is not performed. Accordingly, the processing load applied by a filtering operation is eliminated, and the high-frequency energy of the signal can be converted into a low-frequency component without loss and be mixed with the thinned signal.

The thinned signal obtained as a result of the thinning performed on the frame signal is supplied and stored into the thinned signal buffer 27. The thinned signal buffer 27 stores a predetermined number of past samples (equivalent to approximately 40 to 200 ms) including the latest sample, and these thinned signal samples are used for generating an interpolation signal when there is missing frame data.

After the procedure in step S17 is carried out, and the thinned signal is stored, the decoding process comes to an end, and a decoding process for the frame data of the next frame is performed.

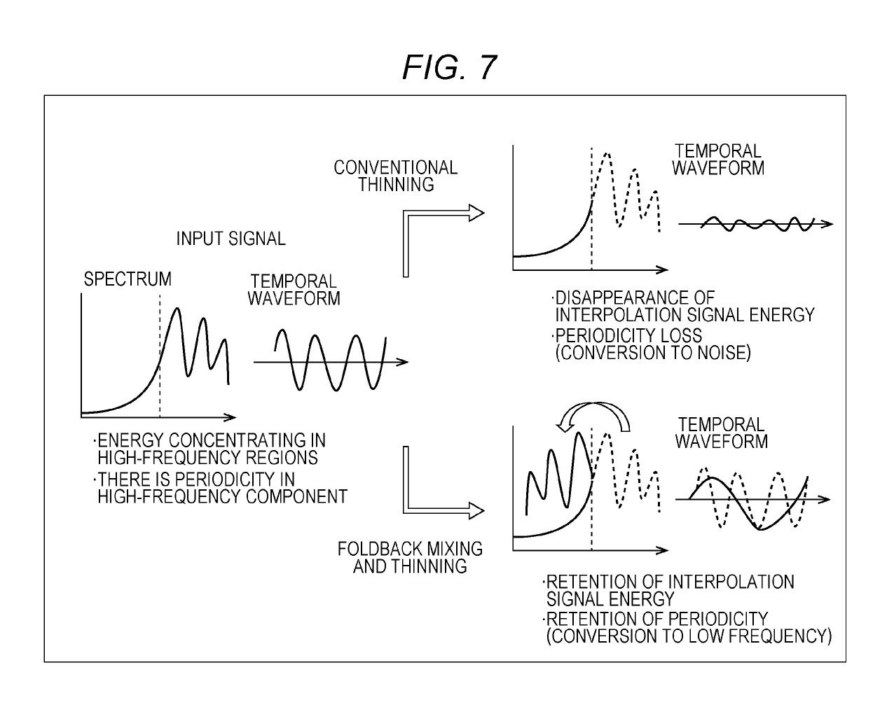

FIG. 7 is a diagram showing the effects of mixing of a foldback component.

As shown in the left side of FIG. 7, an input signal in this case has energy with periodicity concentrating in high-frequency regions but has no energy in low-frequency regions. When a thinning process is carried out to perform conventional foldback cut filtering on this signal, the energy and the periodicity in the high-frequency regions disappear from the thinned signal, and only a very weak low-frequency component that has noise characteristics remains in the signal, as shown in the upper right portion of the drawing.

When an interpolation signal is generated based on this signal, energy disappears from the original signal, and the acoustic quality of the interpolating process is degraded due to conversion into noise.

In the spectrum of the input signal shown in the left side of the drawing, the energy of the input signal concentrate in the high-frequency side, and the high-frequency component has periodicity. A thinning process that is normally performed is performed on such an input signal.

When a conventional thinning process is performed, a filtering process is performed on an input signal with a low-pass filter, and samples of the resultant signal are thinned. As a result, the spectrum of the signal obtained through the thinning process is as shown in the upper right portion of the drawing. In this example, the spectrum of the obtained signal contains only a low-frequency component, and the waveform of the low-frequency component is substantially the same as the waveform of the low-frequency component of the input signal.

That is, in the conventional thinning process, the energy and the periodicity of the input signal disappear. Therefore, the signal obtained through the thinning process is a signal having a temporal waveform like noise. Degradation of the acoustic quality of output signals cannot be reduced even when an interpolation signal is generated by using a signal obtained in that manner.

On the other hand, at the foldback mixing/thinning unit 26 of the audio signal processing apparatus 11, samples are thinned without the use of a low-pass filter for removing foldback. In this case, as shown in the lower right portion of the drawing, the energy having periodicity in the high-frequency regions is folded back into the low-frequency component, and the high-frequency periodic component has a periodic waveform converted into a low-frequency component. As a result, the energy and the periodicity in the high-frequency regions of the original signal are maintained, and the acoustic quality of the interpolating process can be increased.

That is, at the foldback mixing/thinning unit 26, any process is performed on an input output signal, and samples of the output signal are thinned. Therefore, the high-frequency foldback component of the output signal is mixed into the thinned signal obtained as a result of the thinning. Hereinafter, a process of not performing filtering on an output signal but performing thinning directly on the output signal will be referred to as a foldback mixing/thinning process.

For example, when a foldback mixing/thinning process is performed on the input signal shown in the left side of the drawing, the spectrum of the thinned signal obtained as a result is shown in the lower right portion of the drawing. In this example, the spectrum waveform of the low-frequency component of the thinned signal is the waveform obtained by folding back the high-frequency component of the original input signal into the low-frequency side.

This implies that the high-frequency periodic energy of the original input signal is folded back into the low-frequency side, and is mixed into the thinned signal obtained as a result of the foldback mixing/thinning process. That is, the thinned signal contains the energy and the periodicity (the high-frequency foldback component) contained in the high-frequency component of the original input signal. Accordingly, when an interpolation signal is generated by using the thinned signal obtained in this manner, the acoustic quality of the output signal can be increased. Furthermore, in the foldback mixing/thinning process, a filtering process and the like are not performed, and output signal samples are directly thinned. Accordingly, the processing load for generating an interpolation signal can be greatly reduced.

The process to be performed in a case where the interpolation status “Status” is “1” is now described.

Referring back to the flowchart shown in FIG. 6, if the value of the interpolation status “Status” is determined not to be an even number in step S12, the process moves on to step S18. In this case, the error flag of the current frame is “1”. Therefore, the frame data to be input to the input terminal 21 is dummy data, or any frame data is not to be input.

In step S18, the similar signal detecting unit 28 determines whether the value of the interpolation status “Status” supplied from the interpolation state determining unit 24 is “1”. If the value of the interpolation status “Status” is determined to be “1” in step S18, the process moves on to step S19.

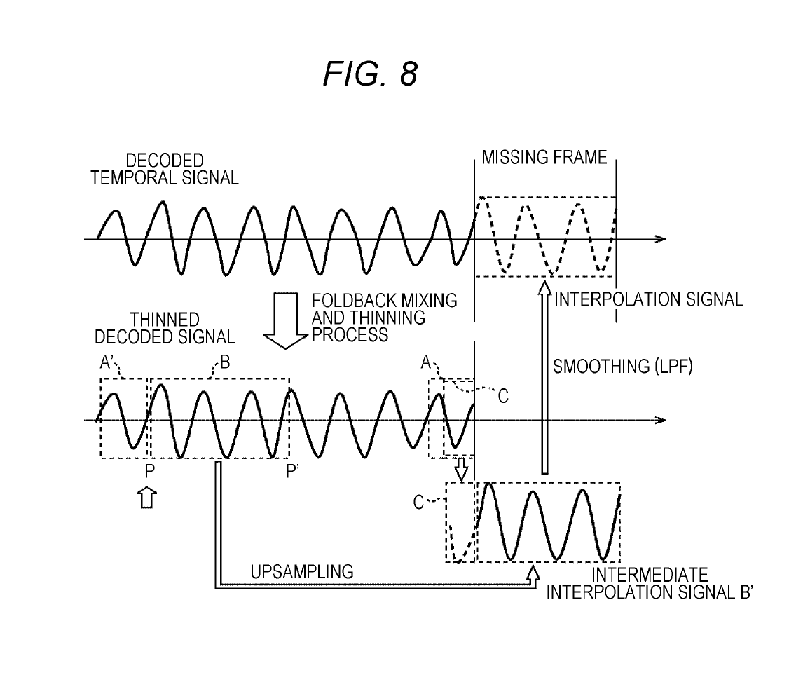

In step S19, the similar signal detecting unit 28 performs an initial search for a similar signal position. Specifically, the similar signal detecting unit 28 reads the past thinned signals from the thinned signal buffer 27, and detects an optimum extracted buffer position for generating an interpolation signal (such as the extracted buffer position P shown in FIG. 8, which will be described later). The similar signal detecting unit 28 supplies information indicating the detected extracted buffer position P to the upsampling unit 29.

For example, the similar signal detecting unit 28 extracts the latest zone among the thinned signals stored in the thinned signal buffer 27, or the thinned signal portion of the time immediately before the audio signal of the missing current frame, and searches for another zone of a thinned signal similar to the extracted zone. The similar signal detecting unit 28 determines the extracted buffer position P to be the position immediately behind the zone obtained through the search.

The signal of the other zone similar to the latest zone among the thinned signals is the thinned signal in the zone similar to the zone located immediately before the current frame of the output signal. Therefore, when an interpolation signal is generated by using the thinned signal located immediately behind such a similar zone, a signal similar to the signal of the current frame of the output signal that has disappeared due to an error should be obtained.

After the initial search is conducted in step S19, the value of the interpolation status “Status” is determined not to be “1” in step S18, or the value of the interpolation status “Status” is determined not to be “0” in step S14, the procedure in step S20 is carried out.

In step S20, the upsampling unit 29 extracts the similar thinned signal of one frame from the extracted buffer position P. For example, based on the information supplied from the similar signal detecting unit 28, the upsampling unit 29 extracts the similar thinned signal, which is the signal in the zone equivalent to the one frame located immediately behind the extracted buffer position P among the thinned signals stored in the thinned signal buffer 27.

In step S21, the upsampling unit 29 generates an intermediate interpolation signal by upsampling the extracted sample (the similar thinned signal) to the original input sampling rate, and supplies the intermediate interpolation signal to the smoothing unit 30. Specifically, the similar thinned signal is upsampled so that the sampling rate for the similar thinned signal becomes the same as the sampling rate for decoded signals (output signals), and the upsampled similar thinned signal is set as the intermediate interpolation signal.

The smoothing unit 30 performs smoothing by performing low-pass filtering on the intermediate interpolation signal supplied from the upsampling unit 29, and generates an interpolation signal. The smoothing unit 30 supplies the generated interpolation signal to the terminal 63 of the output switching unit 25.

In step S22, the switcher 66 of the output switching unit 25 determines whether the value of the interpolation status “Status” supplied from the interpolation state determining unit 24 is “4”.

If the value of the interpolation status “Status” is determined to be “4” in step S22, the process moves on to step S23. If the value of the interpolation status “Status” is determined not to be “4” in step S22, the process moves on to step S24.

As a case where the value of the interpolation status “Status” is “1” is being described herein, the process moves on to step S24.

In step S24, the switcher 66 of the output switching unit 25 switches the switch “Switch” to the terminal T2 on the interpolation signal side. As a result, the terminal T2 is connected to the output terminal 67, and the interpolation signal that is input from the smoothing unit 30 to the terminal T2 via the terminal 63 is supplied as it is to the output terminal 31 via the output terminal 67. That is, the interpolation signal becomes an output signal (a frame signal).

In step S25, the similar signal detecting unit 28 shifts the extracted buffer position P backward by one frame (N samples) in the temporal direction (toward the position P′ shown in FIG. 8).

After the procedure in step S25 is carried out, the process moves on to step S16, and a frame signal (an output signal) is output. Further, the procedure in step S17 is carried out, and the frame signal is thinned to form a thinned signal. After the thinned signal is stored, the decoding processing comes to an end, and a decoding process for the frame data of the next frame is performed. That is, the output of the generated interpolation signal is to be reused for future frame interpolating processes.

Next, a case where the value of the interpolation status “Status” is an odd number (3, 5, or 7) other than “1” is described. In a case where the interpolation status “Status” is “3”, “5”, or “7”, at least the error flag of the current frame is “1”, and at least one of the error flags of the two frames immediately before the current frame is “1”.

If the value of the interpolation status “Status” is determined not to be “1” in step S18, or where the value of the interpolation status “Status” is an odd number other than “1”, step S19 is skipped, and the process moves on to step S20.

In this case, the extracted buffer position P previously detected by the initial search in step S19 is used. More specifically, the extracted buffer position P is a position shifted from the position detected by the initial search by one or a few frames by virtue of the processing in step S25.

In the case where the value of the interpolation status “Status” is an odd number other than “1”, the processing after step S20 is the same as that in the case where the value of the interpolation status “Status” is “1”, and therefore, explanation thereof will not be repeated. That is, the procedures in steps S20 through S17 are carried out, and the decoding process then comes to an end.

Lastly, a case where the value of the interpolation status “Status” is an even number (2, 4, or 6) other than “0” is described.

In this case, if the value of the interpolation status “Status” is determined not to be “0” in step S14, the process moves on to step S20. After that, the procedures in steps S20 and S21 are carried out, to generate an interpolation signal.

After step S21, a check is made to determine whether the value of the interpolation status “Status” is “4” in step S22.

If the value of the interpolation status “Status” is determined not to be “4” in step S22, or where the value of the interpolation status “Status” is “2” or “6”, the process moves on to step S24, and the switcher 66 of the output switching unit 25 switches the switch “Switch” to the terminal T2 on the interpolation signal side. As a result, the terminal T2 is connected to the output terminal 67, and the interpolation signal that is input from the smoothing unit 30 to the terminal T2 via the terminal 63 is supplied as it is to the output terminal 31 via the output terminal 67. That is, the interpolation signal becomes an output signal (a frame signal).

In this case, the input frame data is decoded into a decoded signal by the frame signal decoding unit 23, but this decoded temporal signal (the decoded signal) is not a normal signal since the previous frame had an error. Therefore, the output switching unit 25 does not output this signal but outputs the interpolation signal. The decoded signal obtained at this point is to be used in decoding the next frame.

If the value of the interpolation status “Status” is determined to be “4” in step S22, on the other hand, the process moves on to step S23.

In step S23, the switcher 66 of the output switching unit 25 switches the switch “Switch” to the terminal T1 on the side of a signal subjected to an overlap addition. As a result, the terminal T1 is connected to the output terminal 67, and the signal that has been subjected to an overlap addition and is output from the adder 65 is supplied to the output terminal 31 via the output terminal 67. That is, the signal obtained as a result of a weighted overlap addition of an interpolation signal and a decoded signal is output.

For example, the weighting function (the weight W_{dec}) shown in FIG. 5 is used, and the interpolation signal is overlapped with the decoded signal for the M samples starting from the top of the frame.

Specifically, where the interpolation signal sample is represented by Xcon(n), the decoded signal sample is represented by Xdec(n), the output signal (the frame signal) to be generated is represented by Xout(n), and the frame sample length is represented by N, the output signal Xout(n) is determined by calculating the following equation (1).

Xout(n)=Wdec×Xdec(n)+(1−Wdec)×Xcon(n) (1)

Here, n in Xcon(n), Xdec(n), and Xout(n) are n=0, 1, 2, . . . , N−1.

By calculating this equation (1), an output is generated by overlapping, to form an output (a frame signal). The overlap length M is preferably ¼ to ½ of the frame length N. In this manner, the interpolation signal of the previous frame and the decoded signal are smoothly connected.

In a case where the interpolation status “Status” is “4”, there is no missing frame between the current frame and the frame immediately before the current frame, but a frame disappearance has occurred two frames before the current frame. In the frame immediately before the current frame, the interpolation signal is the output signal. So as to smoothly connect the interpolation signal that has been output as the output signal in the previous frame and the decoded signal obtained as a result of decoding, a signal obtained through a weighted overlap addition is output as an output signal.

After the output signal is obtained by carrying out the procedure in step S23, the procedures in steps S25 through S17 are carried out, and the decoding process comes to an end.

A method of conducting the initial search for a similar signal position in step S19 is now described in detail. This process is performed only when the value of the interpolation status “Status” is “1”. In the initial search, the buffer is searched for the signal that is the most similar to a predetermined sample located immediately before a missing frame, and the buffer position to be used in generating an interpolation signal is detected.

FIG. 8 is a diagram for explaining the flow of such a process. In FIG. 8, the upper portion shows the waveform of a decoded signal sample (the waveform of a decoded signal), and the lower portion shows a thinned signal of a past frame stored in the thinned signal buffer 27.

First, a block A in the drawing indicates a thinned signal sample of predetermined samples (16 to 64 samples, for example) located immediately before a missing frame. That is, the block A is the zone of a thinned signal obtained by thinning an output signal (a decoded signal) located immediately before a missing frame.

A search is conducted to detect the signal that is the most similar to the signal of the block A among the thinned signals stored in the thinned signal buffer 27. For example, a search is conducted to detect the position in which the cross-correlation coefficient becomes largest or the position in which the intervector distance (distortion) becomes smallest.

As a result, the signal of the portion of the block A′ shown in the drawing is obtained as the signal that is the most similar to the signal of the block A. In this case, the point P located immediately behind (on the right side of) the block A′ is the signal extraction position (the extracted buffer position P), and the sample of a block B of the duration equivalent to one frame starting from the extracted buffer position P is used in generating an interpolation signal.

Specifically, at the upsampling unit 29, an intermediate interpolation signal B′ is first generated by upsampling the sample of the block B to the original signal sampling rate through zero insertion. A process of performing low-pass filtering to remove imaging generated by the upsampling is then performed by the smoothing unit 30.

At this point, a signal obtained by upsampling a buffer sample C located immediately before the missing frame is used as the initial state of the filter.

Specifically, the portion of the block C among the thinned signals is the signal located immediately before the intermediate interpolation signal B′, and a filtering process using the signal of the portion of the block C as the initial value of the internal state of the low-pass filter is performed on the intermediate interpolation signal B′, to generate an interpolation signal. As a result, the discontinuity between the generated interpolation signal and the frame signal located immediately before the interpolation signal is reduced, and a smooth connection becomes possible.

That is, this low-pass filtering serves as an imaging removal and a frame connecting process. The interpolation signal subjected to the smoothing process at the smoothing unit 30 is used as a substitute signal in place of the missing frame. The signal obtained by upsampling the buffer sample C at the time immediately before the missing frame is used as the initial value of the internal state of the low-pass filter as described above. However, the output signal immediately before the missing frame may be used as the initial value of the internal state. That is, the output signal of the frame immediately before the current frame may be used as the initial value of the internal state of the low-pass filter.

As described above, the audio signal processing apparatus 11 determines an interpolation status from the error information (the error flag) about a frame, and outputs a signal in accordance with a result of the determination.

In the audio signal processing apparatus 11, a thinned signal obtained by thinning an output signal is used in generating an interpolation signal. Accordingly, the buffer memory that stores past data for generating interpolation signals can be made smaller, and the computation load in the interpolating process at a time of a frame disappearance can be reduced.

Also, in the audio signal processing apparatus 11, the computation load for generating an interpolation signal at a time of regular decoding can be reduced. Furthermore, as a foldback mixing/thinning process is performed, a decrease in the energy of the generated interpolation signal and loss of periodicity can be prevented, and missing data interpolation can be performed with higher acoustic quality.

Also, in the audio signal processing apparatus 11, a smooth connection of an interpolation signal can be performed with a smaller computation load, and acoustic quality can be increased.

### Second Embodiment

### Features of the Present Technique

Next, the features of the present technique to be shown as a second embodiment are described.

Particularly, the present technique has the following features (1) through (4).

(1)

A multichannel audio signal processing apparatus including the following components (i) through (vi).

(i) An audio encoding apparatus that encodes audio signals and an audio decoding apparatus that decodes audio signals in a frame cycle formed with a predetermined number of samples, the predetermined number being 1 or greater.

(ii) A bit stream transmitting/receiving apparatus that transmits an encoded bit stream received from the audio encoding apparatus to the outside, and transmits an encoded bit stream received from the outside to the audio decoding apparatus.

(iii) An audio signal transmitting/receiving apparatus that transmits/receives audio signals for the respective samples, and generates an internal timing signals normally in the above mentioned frame cycle.

(iv) A synchronization processing apparatus that has a function to synchronize the internal timing signal with an external synchronization signal supplied from the outside in the above mentioned frame cycle, and outputs information indicating whether synchronization is established.

(v) A state changing apparatus that acquires the information indicating whether synchronization is established, changes the state to a synchronization complete state for encoding/decoding audio signals and transmitting/receiving an encoded bit stream when synchronization is established, and changes the state to a synchronization incomplete state for awaiting synchronization when synchronization is not established.

(vi) A channel settings changing apparatus that allows a change to the channel settings in response to a request for a channel settings change from the outside even during initialization or operation.

(2)

As for (1), in the audio signal transmitting/receiving apparatus of (iii), sound and audio signals are basically transmitted and received by a double buffer formed with the above mentioned samples, and the internal timing signal is generated when the double buffer is switched. In the synchronization processing apparatus of (iv), a phase difference between the external synchronization signal and the internal timing signal is detected when the external synchronization signal is received. When the detected phase difference exceeds 0 samples, the sample length of one of the buffers is shortened by the amount equivalent to the phase difference, and information indicating that synchronization is not established is output. After that, the shortened sample length is returned to the regular sample length when the buffer is switched from the buffer having its sample length shortened to the buffer having the regular sample length. In this manner, the external synchronization signal and the internal timing signal are synchronized with each other.

(3)

In (1), if the state is the synchronization complete state when a request for a channel settings change is received from the outside, the channel settings changing apparatus changes the state to the synchronization incomplete state and then makes a change to the channel settings.

(4)

In (3), so as to cope with changes in the channel settings during operation, the channel settings changing apparatus secures a memory region that can accommodate a multichannel configuration the audio encoding and decoding apparatuses can have, and secures and initializes static data regions of the sound and audio encoding and decoding apparatuses for the respective channels when a request for a channel settings change is received.

### Structure of an Audio Signal Processing Apparatus

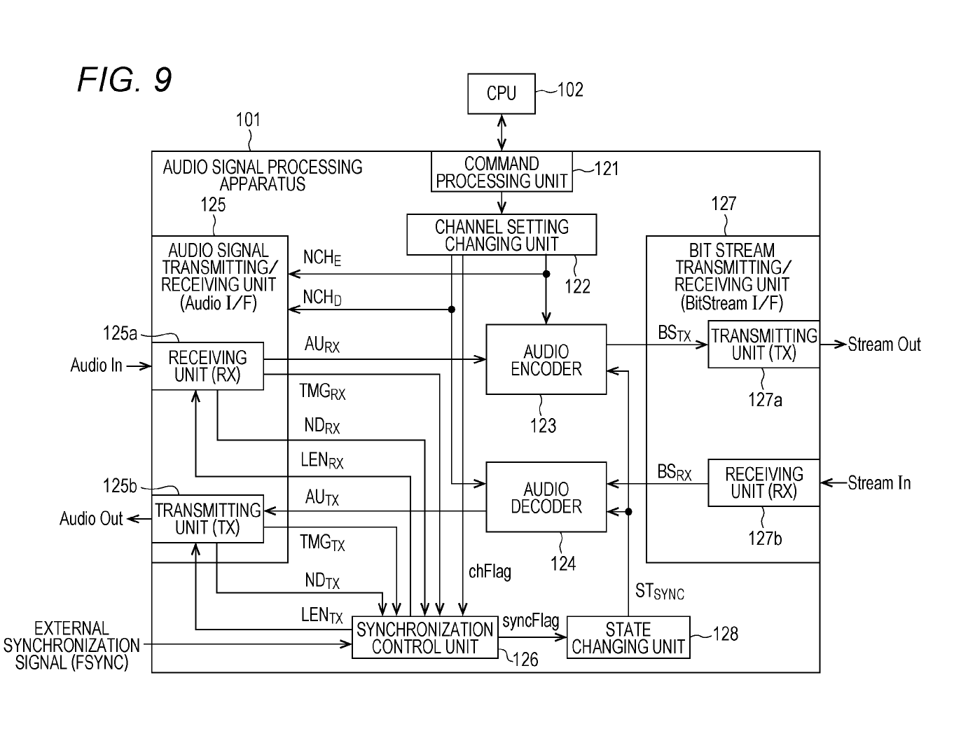

Next, an audio signal processing apparatus to which the present technique is applied is described. FIG. 9 is a diagram showing an example structure of an embodiment of an audio signal processing apparatus to which the present technique is applied.

When the audio signal processing apparatus 101 shown in FIG. 9 receives a request for a change in the channel settings (including the initial settings) from a CPU (Central Processing Unit) 102, a command processing unit 121 interprets the request, and calls a channel settings changing unit 122.

In accordance with the command, the channel settings changing unit 122 sends an encoding channel number NCH_{E} to an audio encoder 123, sends a decoding channel number NCH_{D} to an audio decoder 124, and sends both channel numbers to an audio signal transmitting/receiving unit (Audio I/F) 125.

The channel settings changing unit 122 sets a channel settings change flag chFlag to 1 at a time of a channel settings change, and sends the flag to a synchronization control unit 126.

The audio signal transmitting/receiving unit 125 sets the encoding channel number NCH_{E} and the decoding channel number NCH_{D}, receives audio inputs (Audio In), sends the audio input as audio reception signals (AU_{RX}) to the audio encoder 123, receives audio transmission signals (AU_{TX}) from the audio decoder 124, and transmits the audio transmission signals as audio outputs (Audio Out).

In the audio signal transmitting/receiving unit 125, a receiving unit (RX) 125a transmits reception timing signals TMG_{RX} generated in a frame cycle basically formed with NF samples, and a received sample counter ND_{RX} indicating the number of samples before the next reception timing signal TMG_{RX}, to the synchronization control unit 126.

Likewise, a transmitting unit (TX) 125b of the audio signal transmitting/receiving unit 125 transmits transmission timing signals TMG_{TX} generated in a frame cycle basically formed with NF samples, and a transmitted sample counter ND_{RX} indicating the number of samples before the next transmission timing signal TMG_{TX}, to the synchronization control unit 126.

The audio encoder 123 encodes audio reception signals (AU_{RX}) of NCH_{E} channels, and transmits the results as a transmission bit stream BS_{TX} to a bit stream transmitting/receiving unit (Bitstream I/F) 127. The audio decoder 124 decodes a bit stream BS_{RX} received by the bit stream transmitting/receiving unit 127, and transmits audio transmission signals (AU_{TX}) of NCH_{D} channels.

The synchronization control unit 126 receives an external synchronization signal (FSYNC), also receives a reception timing signal TMG_{RX}, a received sample counter ND_{RX}, a transmission timing signal TMG_{TX}, and a transmitted sample counter ND_{TX} from the audio signal transmitting/receiving unit 125, transmits a corrected reception frame length LEN_{RX} to the receiving unit 125a, and transmits a corrected transmission frame length LEN_{TX} to the transmitting unit 125b.

The synchronization control unit 126 also outputs a synchronization state flag syncFlag to a state changing unit 128. The synchronization state flag syncFlag is set to 1 at a time of synchronization, and is set to 0 at any other time. Further, upon receipt of the channel settings change flag chFlag set to 1 by the channel settings changing unit 122, the synchronization control unit 126 sets the synchronization state flag syncFlag to 0, and then outputs the synchronization state flag syncFlag.

When receiving the synchronization state flag syncFlag indicating asynchronization (syncFlag=0), the state changing unit 128 changes the state to a synchronization incomplete state, sets a synchronization state variable ST_{SYNC} to 0, and initializes the audio encoder 123 and the audio decoder 124. When receiving the synchronization state flag syncFlag indicating synchronization (syncFlag=1), the state changing unit 128 changes the state to a synchronization complete state, sets the synchronization state variable ST_{SYNC} to 1, causes the audio encoder 123 to perform audio signal encoding, and causes the audio decoder 124 to perform audio signal decoding.

In the audio signal transmitting/receiving unit 125, a double buffer (not shown) to be used for receiving and encoding audio inputs is also provided. For example, where one of the buffers constituting the double buffer is a buffer 0, and the other one of the buffers is a buffer 1, these buffers are alternately used as an input buffer for receiving processes and a working buffer for encoding processes.

Specifically, where the buffer 0 is used as the input buffer, and the buffer 1 is used as the working buffer, the audio reception signals of the already received previous frame are stored in the working buffer.

In this state, the receiving unit 125a stores audio inputs received from outside based on an encoding channel number NCH_{E} as audio reception signals into the input buffer. At this point, the receiving unit 125a supplies the number of samples to be processed before all the audio reception signals of the frame being processed are stored into the input buffer as the received sample counter ND_{RX} to the synchronization control unit 126.

Meanwhile, the audio encoder 123 reads the audio reception signals of the previous frame stored in the working buffer, encodes the read audio reception signals, and supplies the results to the transmitting unit 127a.

The receiving unit 125a receives all the audio reception signals of one frame, stores the received audio reception signals into the input buffer, switches the input buffer and the working buffer, and supplies the reception timing signal TMG_{RX} to the synchronization control unit 126. As a result, the buffer 0, which has been used as the input buffer, becomes the working buffer, and the buffer 1, which has been used as the working buffer, becomes the input buffer. The next frame is then received and encoded. That is, the audio reception signals of the new frame are stored into the buffer 1 serving as the input buffer, and the audio reception signals stored in the buffer 0 serving as the working buffer are encoded.

In the audio signal transmitting/receiving unit 125, a double buffer (not shown) to be used by the transmitting unit 125b is also provided like the double buffer to be used by the receiving unit 125a. In this double buffer, one of the buffers is used as an output buffer for transmitting audio transmission signals, and the other one of the buffers is used as the working buffer for decoding a reception bit stream.

Specifically, transmission of audio transmission signals is performed with the use of the output buffer based on a decoding channel number NCH_{D}, and a transmitted sample counter ND_{TX} is supplied from the transmitting unit 125b to the synchronization control unit 126 in accordance with the transmission state. That is, the decoded audio transmission signals stored in the output buffer are read and transmitted. At this point, audio transmission signals obtained by the audio decoder 124 decoding a reception bit stream are sequentially stored into the working buffer by the audio decoder 124.

Transmission of the audio transmission signals of one frame is performed, and the output buffer and the working buffer are switched. A transmission timing signal TMG_{TX} is then supplied from the transmitting unit 125b to the synchronization control unit 126.

In the audio signal processing apparatus 101, a memory (not shown) that is shared between the audio encoder 123 and the audio decoder 124 is further provided, and a static data storage region in which information necessary for encoding and decoding audio signals is secured in the memory. For example, in the static data storage region, bit rates, state variables, and the like as the information about the signals of the previous frame are stored as information about the audio signals of the respective channels to be encoded or decoded. The audio encoder 123 and the audio decoder 124 encode and decode audio signals by referring to the information about the respective channels stored in the static data storage region.

Reception, encoding, decoding, and transmission of audio signals are performed for each frame of audio signals, but those processes need to be performed in synchronization with other external processes such as video signal processing. That is, the respective processes to be performed by the audio signal processing apparatus 101, or more specifically, the timings to generate a reception timing signal TMG_{RX} and a transmission timing signal TMG_{TX}, need to be synchronized with the timings to generate an external synchronization signal.

Therefore, based on a received sample counter ND_{RX} and a transmitted sample counter ND_{TX} supplied from the audio signal transmitting/receiving unit 125, the synchronization control unit 126 synchronizes the respective processes to be performed on audio signals by the audio signal processing apparatus 101 with an external synchronization signal.

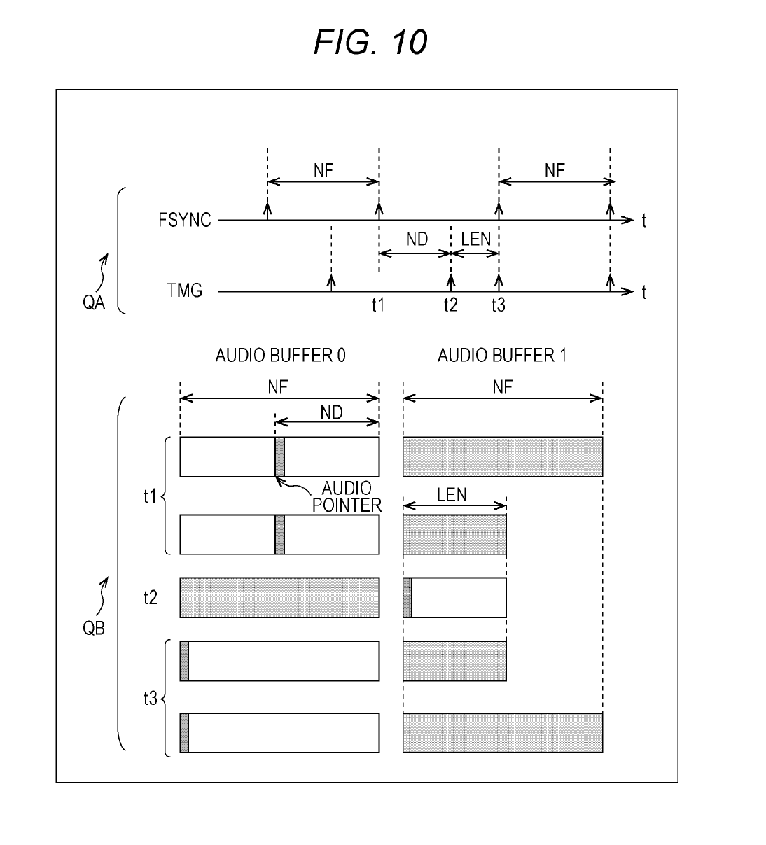

Referring now to FIG. 10, a method of synchronizing audio frames with external synchronization signals by the audio signal transmitting/receiving unit 125 and the synchronization control unit 126 is described.

In FIG. 10, the portion indicated by an arrow QA is a timing chart of an external synchronization signal (FSYNC) and an internal timing signal (TMG) of an audio frame. The portion indicated by an arrow QB shows a method of synchronizing internal timing signals (TMG) by using a double buffer.

Since the process of controlling internal timing signals (TMG) is the same for transmission and reception, the symbols TX and RX are not shown. Specifically, in the description below, when there is no particular need to distinguish a reception timing signal TMG_{RX} and a transmission timing signal TMG_{TX} from each other, those signals will be also referred to as internal timing signals TMG.

Prior to time t1, an external synchronization signal (FSYNC) and an internal timing signal (TMG) are generated every NF samples, which are equivalent to one frame cycle.

As indicated by the arrow QB, the audio buffer is a double buffer, and two buffers each having a sample length NF are alternately used as an audio input (output) buffer and a working buffer. Every time the buffers are switched, an internal timing signal TMG is generated. The audio buffer 0 and the audio buffer 1 shown in FIG. 10 constitute the double buffer provided in the audio signal transmitting/receiving unit 125. Which one of the receiving unit 125a and the transmitting unit 125b uses the double buffer formed with the audio buffer 0 and the audio buffer 1 is not specifically defined herein.

At time t1, when an external synchronization signal (FSYNC) is input, the audio buffer 0 is operating as the audio input (output) buffer, and the audio buffer 1 is operating as the working buffer. At this point, the audio pointer is located at the sample counter ND. The value of ND is equivalent to the phase difference between the current external synchronization signal and the current internal timing signal. If this value is smaller than the frame length NF, the state is a synchronization incomplete state, and the synchronization state flag syncFlag is set to 0.

In short, the position of the audio pointer in the audio buffer 0 at time t1 indicates the positions of the samples for which audio signal reception or transmission has been completed. In other words, the position of the audio pointer indicates the number of audio signal samples to be processed before reception or transmission is completed for the frame being processed.

Therefore, the number of samples specified by the position of the audio pointer is output as a sample counter ND, which is a received sample counter ND_{RX} or a transmitted sample counter ND_{TX}, to the synchronization control unit 126.

In a state where synchronization between an external synchronization signal and an internal timing signal is completed, there is no phase difference, and the other one of the buffers in the double buffer is now the input (output) buffer. Therefore, the value of the sample counter ND is the same as the value of NF.

At this point, the operation enters a synchronization establishing process, and the buffer length LEN of the audio buffer 1 currently serving as the working buffer is changed according to the following equation (2).

LEN=NF−ND (2)

In the equation (2), the difference between the frame cycle NF and the sample counter ND is equal to the buffer length LEN of the audio buffer 1 after a change. The buffer length LEN of the audio buffer 1 changed in the above manner is supplied as a corrected reception frame length LEN_{RX} or a corrected transmission frame length LEN_{TX} from the synchronization control unit 126 to the receiving unit 125a or the transmitting unit 125b.

At time t2, which is a time to switch the double buffer, an internal timing signal TMG is generated, the audio buffer 0 becomes the working buffer, and the audio buffer 1 becomes the input (output) buffer.

For example, if the audio buffer 1 is the input buffer, the audio signals of a new frame to be processed are stored into the input audio buffer 1. In this case, the buffer length of the audio buffer 1 is “LEN”, which is smaller than the number of samples of one frame. Therefore, when LEN samples are stored into the audio buffer 1, which is time t3, double buffer switching is performed. In other words, the period before double buffer switching is shortened by the amount equivalent to the sample counter ND.

At time t3, when the audio pointer comes to the position of the buffer length LEN, the audio buffers are switched, and an internal timing signal TMG is generated at the same time as generation of an external synchronization signal. At this point, under the control of the synchronization control unit 126, the buffer length of the audio buffer 1 is returned to NF, which is the original unchanged length, and the synchronization state flag syncFlag is set to 1, which indicates a synchronization complete state. That is, the buffer length of the audio buffer 1 that has been shortened to the duration of time before the double buffer switching by the amount equivalent to the phase difference between an external synchronization signal and an internal timing signal is recovered to the original unshortened length.

Through the above described process, synchronization between an external synchronization signal and an audio frame is established. The frame after the frame processed at time t2 becomes the frame to be processed, and the audio signals of the frame are encoded or decoded.

Next, an audio channel settings changing process is described.

First, a method of statically securing static data regions in the audio encoder 123 and the audio decoder 124 is described.

In the audio signal processing apparatus 101, the static data size of the encoder is SE bytes per channel, and the static data size of the decoder is SD bytes per channel. Further, the largest possible number of channels of the encoder is MCH_E, and the largest possible number of channels of the decoder is MCH_D.

At this point, the size TS (bytes) of a memory region that can accommodate data of all the channels is expressed by the following equation (3).

TS=MCH_{—}E·SE+MCH_{—}D·SD (3)

In view of this, a static data storage region of TS bytes is secured in a memory (not shown) in the audio signal processing apparatus 101 at the time of initialization of the audio signal processing apparatus 101.

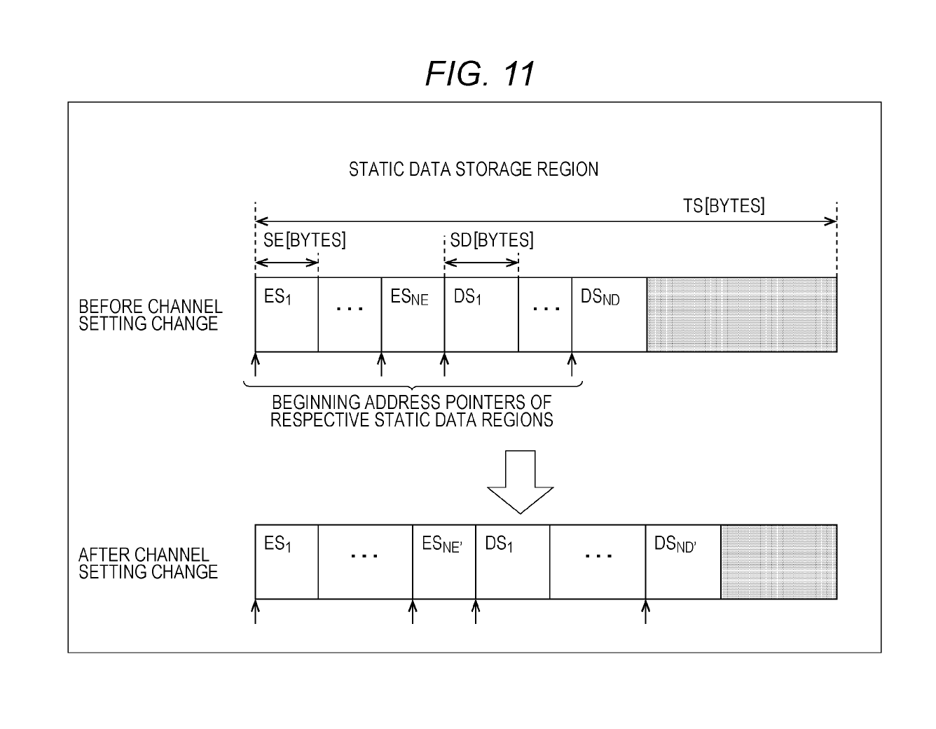

FIG. 11 shows a method of securing static data regions of the respective channels when the channel settings are changed.

Prior to a change of the channel settings, the number of channels of the encoder in the audio encoder 123 is set as NE, and the number of channels of the decoder in the audio decoder 124 is set as ND. Static data regions ESₙ of the encoder and static data regions DSₙ (n being channel number) are secured in the static data storage region.

Each of the static data regions designate a beginning address pointer. Each static data region of the encoder occupies SE bytes, which is the static data size of the encoder, and each static data region of the decoder occupies SD bytes, which is the static data size of the decoder. Here, the respective beginning address pointers indicate the positions of the tops of the respective static data regions ESₙ and DSₙ.

The information necessary for encoding audio signals of the respective channels, such as bit rates and state variables, is stored in the static data regions ESₙ provided for the respective channels. Likewise, the information necessary for decoding audio signals of the respective channels, such as bit rates and state variables, is stored in the static data regions DSₙ provided for the respective channels.

If the number of channels of the encoder is changed to NE′, and the number of channels of the decoder is changed to ND′ in accordance with a request for a change in the channel settings, the beginning address pointers are temporarily released, and the beginning address pointers of new static data regions of the respective channels and the new regions of the static data size are sequentially secured, to complete initialization. In this example, static data regions ES₁ through ES_{NE′} of the encoder, and static data regions DS₁ through DS_{ND′} of the decoder are newly secured in the static data storage region.

As described above, a memory region of a size that can accommodate data of all the channels is secured as a static data storage region beforehand at the time of initialization of the audio signal processing apparatus 101, but not in a dynamic manner. Accordingly, data fragmentation can be prevented even when a change is made to the channel settings.

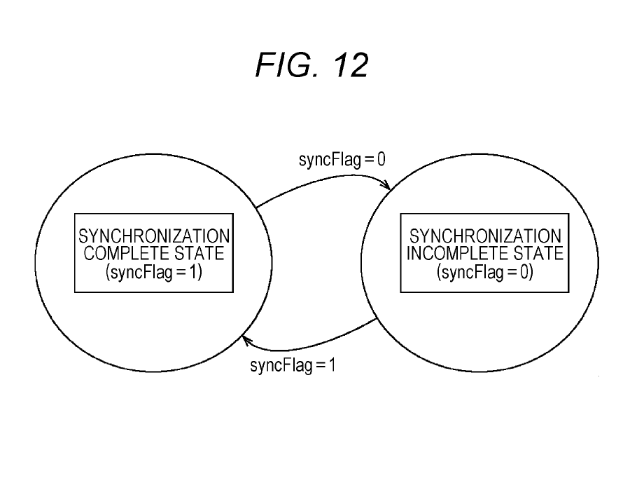

Also, as shown in FIG. 12, the audio signal processing apparatus 101 has the two states of a “synchronization complete state” in which audio signals are synchronized with an external synchronization signal, and a “synchronization incomplete state” in which audio signals are not synchronized with an external synchronization signal. When the value of the synchronization state flag syncFlag output from the synchronization control unit 126 is “1”, the audio signal processing apparatus 101 is in a synchronization complete state. When the value of the synchronization state flag syncFlag is “0”, the audio signal processing apparatus 101 is in a synchronization incomplete state.

Here, if a change is made to the channel settings in a synchronization complete state, the audio encoder 123 and the audio decoder 124 might become unstable.

When a request for a channel settings change is input, the channel settings changing unit 122 sets the channel settings change flag chFlag to 1, and inputs the channel settings change flag chFlag to the synchronization control unit 126. The synchronization control unit 126 sets the synchronization state flag syncFlag to 0. The state changing unit 128 switches the state to a synchronization incomplete state. The audio encoder 123 and the audio decoder 124 are initialized for the respective channels after the change in the channel settings. The state changing unit 128 maintains the synchronization incomplete state until the synchronization control unit 126 establishes synchronization and outputs the synchronization state flag syncFlag=1.

### Description of Encoding and Decoding Processes

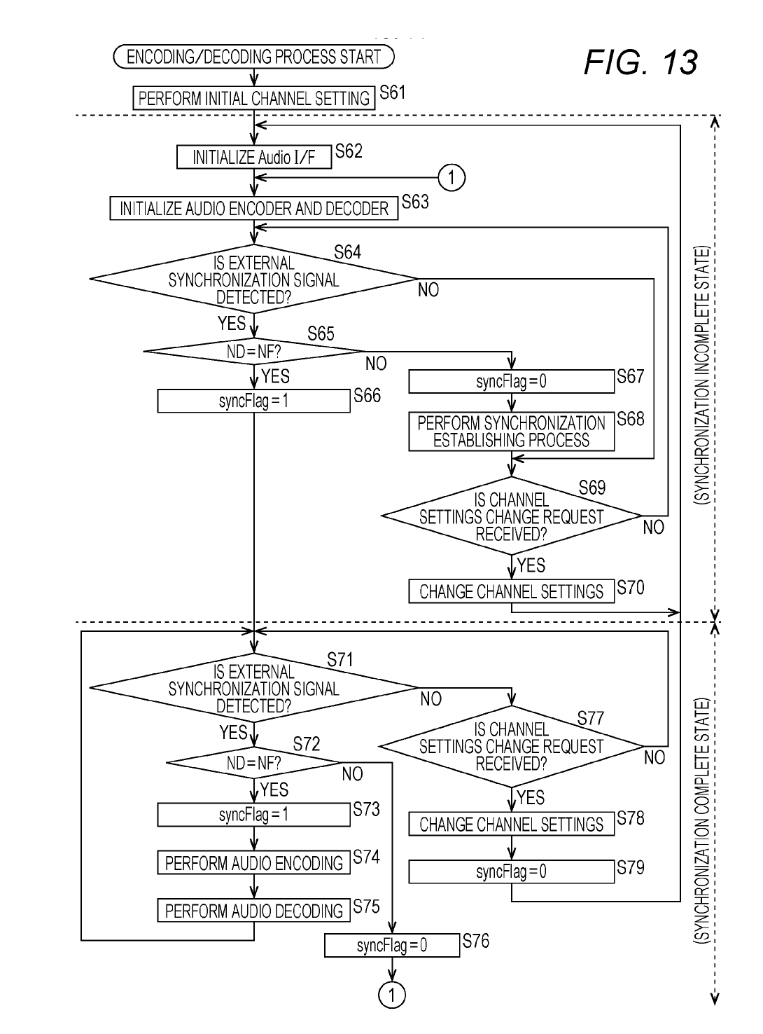

Referring now to the flowchart shown in FIG. 13, an encoding/decoding process to be performed by the audio signal processing apparatus 101 is described.

In step S61, the command processing unit 121 sends a channel settings change command received by the CPU 102 to the channel settings changing unit 122. The channel settings changing unit 122 then sends the channel settings change command from the command processing unit 121 to the audio signal transmitting/receiving unit (Audio I/F) 125, the audio encoder 123, and the audio decoder 124.

In step S62, the audio signal transmitting/receiving unit 125 performs initialization in accordance with channel settings. In step S63, the audio encoder 123 and the audio decoder 124 are initialized.

For example, in step S62, the audio signal transmitting/receiving unit 125 sets the number of encoding channels and the number of decoding channels based on a encoding channel number NCH_{E} and a decoding channel number NCH_{D} supplied from the channel settings changing unit 122 together with the channel settings change command.

In step S63, based on the encoding channel number NCH_{E} and the decoding channel number NCH_{D}, the audio signal processing apparatus 101 secures the static data regions ES' through ES_{NE′} and the static data regions DS' through DS_{ND′} of the decoder shown in FIG. 11 in a static data storage region in a memory, for example. Further, the audio encoder 123 and the audio decoder 124 store bit rates, initial values of state variables, and the like for the respective channels into the static data regions secured in the static data storage region.

In step S64, the synchronization control unit 126 determines whether an external synchronization signal has been input. If an input of an external synchronization signal is detected in step S64, the process moves on to step S65.

In step S65, the synchronization control unit 126 determines whether the values of sample counters ND are equal to a frame cycle NF. Specifically, the synchronization control unit 126 determines the values of the sample counters ND of a received sample counter ND_{RX} from the receiving unit 125a and a transmitted sample counter ND_{TX} from the transmitting unit 125b are equal to the frame cycle NF.

If the values of the sample counters ND are determined to be equal to the frame cycle NF in step S65, the process moves on to step S66. Since the sample counters ND are equal to the frame cycle NF in this case, the external synchronization signal (FSYNC) and the internal timing signal (TMG) are in synchronization with each other.

In step S66, the synchronization control unit 126 sets the synchronization state flag syncFlag to 1, to complete synchronization. The process then moves on to step S71 so that the state changing unit 128 moves on to a synchronization complete state. At this point, the synchronization control unit 126 supplies the synchronization state flag syncFlag of “1” to the state changing unit 128.

If an input of an external synchronization signal is not detected by the synchronization control unit 126 in step S64, the process moves on to step S69.

Further, if the values of the sample counters ND are determined not to be equal to the frame cycle NF in step S65, the process moves on to step S67. Since the sample counters ND are not equal to the frame cycle NF in this case, the external synchronization signal (FSYNC) and the internal timing signal (TMG) are not in synchronization with each other.

In step S67, the synchronization control unit 126 sets the synchronization state flag syncFlag to 0, and supplies the synchronization state flag syncFlag to the state changing unit 128.

In step S68, the respective processes at time t1 to time t3 described with reference to FIG. 10 are carried out in the synchronization establishing process.

Specifically, the synchronization control unit 126 calculates a changed buffer length LEN of the audio buffer according to the above mentioned equation (2), and supplies the obtained buffer length LEN as a corrected reception frame length LEN_{RX} or a corrected transmission frame length LEN_{TX} to the receiving unit 125a or the transmitting unit 125b. The receiving unit 125a and the transmitting unit 125b then change the buffer length of the audio buffers being used as the working buffers in the audio signal transmitting/receiving unit 125.

Accordingly, when the working audio buffer and the input/output audio buffer are switched, or when double buffer switching is performed, the external synchronization signal (FSYNC) and the internal timing signal (TMG) are synchronized with each other.

In a case where the synchronization establishing process is performed in step S68, or where an input of an external synchronization signal is not detected in step S64, the procedure in step S69 is carried out.

Specifically, in step S69, the channel settings changing unit 122 determines whether a request for a channel settings change is received.

If it is determined in step S69 that a request for a channel settings change is received, the channel settings changing unit 122 in step S70 changes the channel settings. After that, the process returns to step S62, and the above described procedures are repeated.

Specifically, the channel settings changing unit 122 sets the channel settings change flag chFlag to 1, and supplies the flag to a synchronization control unit 126. The channel settings changing unit 122 also supplies an encoding channel number NCH_{E} to the audio encoder 123 and the audio signal transmitting/receiving unit 125, and supplies a decoding channel number NCH_{D} to the audio decoder 124 and the audio signal transmitting/receiving unit 125.

If it is determined in step S69 that a request for a channel settings change is not received, on the other hand, the process returns to step S64, and the above described procedures are repeated.

After the synchronization state flag syncFlag is set to 1 in step S66, the synchronization control unit 126 in step S71 determines whether an external synchronization signal has been detected.

If it is determined in step S71 that an external synchronization signal has been detected, the synchronization control unit 126 in step S72 determines whether the sample counters ND are equal to the frame cycle NF.

If the values of the sample counters ND are determined to be equal to the frame cycle NF in step S72, the synchronization state is continued, and the process moves on to step S73.

In step S73, the synchronization control unit 126 sets the synchronization state flag syncFlag to 1, and supplies the synchronization state flag syncFlag to the state changing unit 128. The state changing unit 128 sets the synchronization state variable ST_{SYNC} to 1 in accordance with the synchronization state flag from the synchronization control unit 126, and supplies the synchronization state variable ST_{SYNC} to the audio encoder 123 and the audio decoder 124. That is, the state becomes a synchronization complete state.

In step S74, the audio encoder 123 performs audio encoding. Further, in step S75, the audio decoder 124 performs audio decoding. Specifically, the audio encoder 123 encodes audio reception signals from the receiving unit 125a, and supplies the results to the transmitting unit 127a. The audio decoder 124 decodes a reception bit stream from the receiving unit 127b, and supplies the results to the transmitting unit 125b. After the audio decoding is performed, the process returns to step S71, and the above described procedures are repeated.

If the values of the sample counters ND are determined not to be equal to the frame cycle NF in step S72, the synchronization state is not continued, and the process moves on to step S76. In this case, the external synchronization signal and the internal timing signal are not in synchronization with each other for some reason.

In step S76, the synchronization control unit 126 sets the synchronization state flag syncFlag to 0, and the state is changed to a synchronization incomplete state by the state changing unit 128. That is, after the procedure in step S76 is carried out, the process returns to step S63, and the above described procedures are repeated.

Specifically, when the synchronization state flag syncFlag of 0 is supplied from the synchronization control unit 126 to the state changing unit 128, the state changing unit 128 sets the synchronization state variable ST_{SYNC} to 0, and supplies the synchronization state variable ST_{SYNC} to the audio encoder 123 and the audio decoder 124. As a result, the state becomes a synchronization incomplete state, and the encoding process by the audio encoder 123 and the decoding process by the audio decoder 124 are stopped. The encoding process and the decoding process are suspended when the external synchronization signal and the internal timing signal are not in synchronization with each other, so that the audio encoder 123 and the audio decoder 124 are initialized. In this manner, the audio signal processing apparatus 101 can be prevented from becoming unstable.

If an input of an external synchronization signal is not detected by the synchronization control unit 126 in step S71, the process moves on to step S77.

Specifically, in step S77, the channel settings changing unit 122 determines whether a request for a channel settings change is received.

If it is determined in step S77 that a request for a channel settings change is received, the channel settings changing unit 122 in step S78 makes a change to the channel settings, sets the channel settings change flag chFlag to 1, and sends the channel settings change flag chFlag to the synchronization control unit 126. The channel settings changing unit 122 also supplies an encoding channel number NCH_{E} to the audio encoder 123 and the audio signal transmitting/receiving unit 125, and supplies a decoding channel number NCH_{D} to the audio decoder 124 and the audio signal transmitting/receiving unit 125.

In step S79, the synchronization control unit 126 sets the synchronization state flag syncFlag to 0, and supplies the synchronization state flag syncFlag to the state changing unit 128. So as to initialize the audio encoder 123 and the audio decoder 124, the state changing unit 128 sets the synchronization state variable ST_{SYNC} to 0, and moves on to a synchronization incomplete state. That is, after the procedure in step S79 is carried out, the process returns to step S62, and the above described procedures are repeated.

After the state becomes a synchronization incomplete state as a result of the procedure in step S79, the encoding process by the audio encoder 123 and the decoding process by the audio decoder 124 are stopped, and the external synchronization signal and the internal timing signal are synchronized with each other. While the encoding process and the decoding process are suspended, the external synchronization signal and the internal timing signal are synchronized with each other. In this manner, the audio signal processing apparatus 101 can be prevented from becoming unstable.

If it is determined in step S77 that a request for a channel settings change is not received, on the other hand, the process returns to step S71, and the above described procedures are repeated.

In the above described manner, the audio signal processing apparatus 101 establishes synchronization between an external synchronization signal and an audio frame, and encodes and decodes audio signals.

In the audio signal processing apparatus 101, when audio signals are synchronized with signals such as image signals and are then processed, states are classified into the two states of a synchronization complete state and a synchronization incomplete state based on an external synchronization signal. In this manner, tasks to be processed can be clearly distinguished from one another, and complexity can be avoided.

Also, in a process of synchronizing an internal timing signal generated at the audio signal transmitting/receiving unit 125 with an external synchronization signal, a phase difference between the external synchronization signal and the internal timing signal is detected with the use of a double buffer, and the buffer length of one of the buffers in the double buffer is changed based on the phase difference. In this manner, the timing to generate the internal timing signal is shifted, and the external synchronization signal and the internal timing signal can be synchronized with each other with a small resource.

Furthermore, in a process of changing the channel settings, static data regions of the audio encoder 123 and the audio decoder 124 are statically secured in the static data storage region. Accordingly, even when the audio signal processing apparatus 101 is in operation, the static data regions of the encoder and the decoder of each channel can be provided without fragmentation of the memory. Even when an external synchronization signal and the audio signal processing apparatus 101 are in synchronization with each other, the state can temporarily enter a synchronization incomplete state, and the static data regions of the encoder and the decoder of each channel are secured and initialized. In this manner, the audio signal processing apparatus 101 can be prevented from becoming unstable.

It should be noted that the above described series of processes may be performed by hardware or may be performed by software. When the series of processes are to be performed by software, the programs forming the software are installed into a computer. Here, the computer may be a computer incorporated into special-purpose hardware, or may be a general-purpose personal computer that can execute various kinds of functions by installing various kinds of programs thereinto.

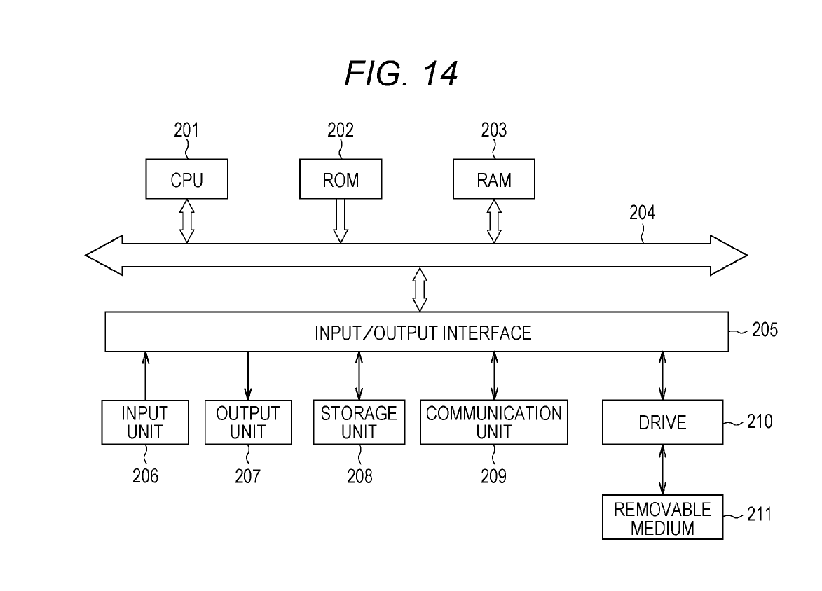

FIG. 14 is a block diagram showing an example structure of the hardware of a computer that performs the above described series of processes in accordance with programs.

In the computer, a CPU (Central Processing Unit) 201, a ROM (Read Only Memory) 202, and a RAM (Random Access Memory) 203 are connected to one another by a bus 204.

An input/output interface 205 is further connected to the bus 204. An input unit 206, an output unit 207, a storage unit 208, a communication unit 209, and a drive 210 are connected to the input/output interface 205.

The input unit 206 is formed with a keyboard, a mouse, a microphone, an imaging element, and the like. The output unit 207 is formed with a display, a speaker, and the like. The storage unit 208 is formed with a hard disk, a nonvolatile memory, or the like. The communication unit 209 is formed with a network interface or the like. The drive 210 drives a removable medium 211 such as a magnetic disk, an optical disk, a magnetooptical disk, or a semiconductor memory.

In the computer having the above described structure, the CPU 201 loads programs stored in the storage unit 208 into the RAM 203 via the input/output interface 205 and the bus 204, and executes the programs, so that the above described series of processes are performed.

The programs to be executed by the computer (the CPU 201) may be recorded on the removable medium 211 as a packaged medium to be provided, for example. Alternatively, the programs can be provided via a wired or wireless transmission medium such as a local area network, the Internet, or digital satellite broadcasting.

In the computer, the programs can be installed into the storage unit 208 via the input/output interface 205 when the removable medium 211 is mounted on the drive 210. The programs can also be received by the communication unit 209 via a wired or wireless transmission medium, and be installed into the storage unit 208. Other than that, the programs can be installed beforehand into the ROM 202 or the storage unit 208.

The programs to be executed by the computer may be programs for performing processes in chronological order in accordance with the sequence described in this specification, or may be programs for performing processes in parallel or performing a process when necessary, such as when there is a call.

It should be noted that embodiments of the present technique are not limited to the above described embodiments, and various modifications may be made to them without departing from the scope of the present technique.

For example, the present technique can be embodied in a cloud computing structure in which one function is shared among apparatuses via a network, and processing is performed by the apparatuses cooperating with one another.

The respective steps described with reference to the above described flowcharts can be carried out by one apparatus or can be shared among apparatuses.

In a case where more than one process is included in one step, the processes included in the step can be performed by one apparatus or can be shared among apparatuses.

Further, the present technique may take the following forms.

[1]

A decoding apparatus including:

a decoding unit that generates a decoded signal by decoding an audio signal on a frame basis;

a thinning unit that generates a thinned signal by performing a thinning process on an output signal that is output earlier;

an interpolation signal generating unit that generates an interpolation signal based on the thinned signal; and

an output switching unit that outputs the decoded signal or the interpolation signal as the output signal in accordance with error information about the frame.

The decoding apparatus of [1], wherein the thinning unit performs the thinning process directly on the output signal, to generate the thinned signal into which a high-frequency foldback component of the output signal is mixed.

[3]

The decoding apparatus of [1] or [2], further including:

a thinned signal storing unit that stores the thinned signal; and

a similar signal detecting unit that detects a similar zone that is similar to the zone of the thinned signal of the time immediately before the audio signal having disappeared among the thinned signals stored in the thinned signal storing unit when the audio signal has disappeared from the frame being processed,

wherein the interpolation signal generating unit generates the interpolation signal based on the signal in the zone immediately after the similar zone among the thinned signals stored in the thinned signal storing unit.

[4]

The decoding apparatus of [3],

wherein the interpolation signal generating unit upsamples the signal in the zone immediately after the similar zone among the thinned signals stored in the thinned signal storing unit, and

the decoding apparatus further includes a smoothing unit that performs a filtering process using a low-pass filter on the signal upsampled by the interpolation signal generating unit, and sets the filtered signal as the interpolation signal.

[5]

The decoding apparatus of [4], wherein the smoothing unit uses the audio signal immediately before the audio signal having disappeared from the frame being processed, or the signal obtained by upsampling the thinned signal of the time immediately before the audio signal having disappeared, as the initial value of the internal state of the low-pass filter.

[6]

The decoding apparatus of any of [1] through [5], wherein the thinning unit generates the thinned signal by performing the thinning process on the decoded signal or the interpolation signal, whichever is output as the output signal from the output switching unit.

[7]

The decoding apparatus of any of [1] through [6], further including an interpolation state determining unit that determines an interpolation status based on the error information about the frame, wherein the output switching unit generates a combined signal by performing a weighted overlap addition on the interpolation signal and the decoded signal, and outputs the decoded signal, the interpolation signal, or the combined signal as the output signal in accordance with the interpolation status.

[8]

A decoding method including the steps of:

generating a decoded signal by decoding an audio signal on a frame basis;

generating a thinned signal by performing a thinning process on an output signal that is output earlier;

generating an interpolation signal based on the thinned signal; and

outputting the decoded signal or the interpolation signal as the output signal in accordance with error information about the frame.

[9]

A program for causing a computer to perform a process including the steps of:

generating a decoded signal by decoding an audio signal on a frame basis;

generating a thinned signal by performing a thinning process on an output signal that is output earlier;

generating an interpolation signal based on the thinned signal; and

outputting the decoded signal or the interpolation signal as the output signal in accordance with error information about the frame.

[10]

An audio signal processing apparatus including:

a timing signal generating unit that outputs an internal timing signal when a double buffer is switched while an audio signal is processed by using the double buffer formed with two buffers each having a predetermined length; and

a synchronization control unit that synchronizes the internal timing signal with an external timing signal supplied from the outside when the internal timing signal and the external timing signal are not in synchronization, by shortening the duration of time before the switching in the double buffer by the amount equivalent to the phase difference between the internal timing signal and the external timing signal.

[11]

The audio signal processing apparatus of [10], further including a state changing unit that changes the current state to a synchronization complete state and continues the processing of the audio signal using the double buffer when the internal timing signal and the external timing signal are in synchronization, and changes the current state to a synchronization incomplete state and suspends the processing of the audio signal when the internal timing signal and the external timing signal are not in synchronization.

[12]

The audio signal processing apparatus of [11], wherein, when processing of the audio signals of channels is controlled and there is a request for a change of the number of channels of the audio signals to be processed, the state changing unit changes the current state to the synchronization incomplete state, and suspends the processing of the audio signal.

[13]

The audio signal processing apparatus of [11] or [12], wherein the synchronization control unit synchronizes the internal timing signal with the external timing signal by shortening the length of one buffer in the double buffer by the amount equivalent to the phase difference and shortening the duration of time before the switching in the double buffer, and returns the duration of time before the next switching in the double buffer to the original unshortened length by returning the shortened length of the buffer to the original length.

[14]

The audio signal processing apparatus of any of [11] through [13],

wherein the timing signal generating unit switches the double buffer and outputs the internal timing signal when the audio signal received is stored into one of the buffers constituting the double buffer and the storing of the audio signal into the one of the buffers is completed,

the state changing unit controls encoding of the audio signal depending on whether the current state is the synchronization complete state or is the synchronization incomplete state, and

the audio signal processing apparatus further includes an encoding unit that encodes the audio signal stored in the other one of the buffers constituting the double buffer when the current state is the synchronization complete state.

[15]

The audio signal processing apparatus of any of [11] through [13],

wherein the timing signal generating unit switches the double buffer and outputs the internal timing signal when the audio signal decoded and stored in one of the buffers constituting the double buffer is transmitted and the transmission of the audio signal from the one of the buffers is completed,

the state changing unit controls decoding of the audio signal depending on whether the current state is the synchronization complete state or is the synchronization incomplete state, and

the audio signal processing apparatus further includes a decoding unit that decodes the audio signal and stores the decoded audio signal into the other one of the buffers constituting the double buffer when the current state is the synchronization complete state.

[16]

The audio signal processing apparatus of [12],

wherein a recording region of a size determined by the largest possible number of channels of the audio signal to be processed is secured as a static data storage region for storing information necessary for processing the audio signal of each channel, and

static data regions of the respective channels for storing the information necessary for processing the audio signal are secured in the static data storage region when there is a request for a change of the number of channels.

[17]

An audio signal processing method including the steps of:

outputting an internal timing signal when a double buffer is switched while an audio signal is processed by using the double buffer formed with two buffers each having a predetermined length; and

synchronizing the internal timing signal with an external timing signal supplied from the outside when the internal timing signal and the external timing signal are not in synchronization, by shortening the duration of time before the switching in the double buffer by the amount equivalent to the phase difference between the internal timing signal and the external timing signal.

[18]

A program for causing a computer to perform a process including the steps of:

outputting an internal timing signal when a double buffer is switched while an audio signal is processed by using the double buffer formed with two buffers each having a predetermined length; and

synchronizing the internal timing signal with an external timing signal supplied from the outside when the internal timing signal and the external timing signal are not in synchronization, by shortening the duration of time before the switching in the double buffer by the amount equivalent to the phase difference between the internal timing signal and the external timing signal.

### REFERENCE SIGNS LIST

11 Audio signal processing apparatus
23 Frame signal decoding unit
24 Interpolation state determining unit
25 Output switching unit
26 Foldback mixing/thinning unit
27 Thinned signal buffer
28 Similar signal detecting unit
30 Smoothing unit
101 Audio signal processing apparatus
122 Channel settings changing unit
123 Audio encoder
124 Audio decoder
126 SYNCHRONIZATION CONTROL UNIT
128 State changing unit

1. A decoding apparatus including:
a decoding unit that generates a decoded signal by decoding an audio signal on a frame basis;
a thinning unit that generates a thinned signal by performing a thinning process on an output signal that is output earlier;
an interpolation signal generating unit that generates an interpolation signal based on the thinned signal; and
an output switching unit that outputs the decoded signal or the interpolation signal as the output signal in accordance with error information about the frame.

2. The decoding apparatus according to claim 1, wherein the thinning unit performs the thinning process directly on the output signal, to generate the thinned signal into which a high-frequency foldback component of the output signal is mixed.

3. The decoding apparatus according to claim 2, further comprising:
a thinned signal storing unit configured to store the thinned signal; and
a similar signal detecting unit configured to detect a similar zone that is similar to a zone of the thinned signal of a time immediately before the audio signal having disappeared among the thinned signals stored in the thinned signal storing unit when the audio signal has disappeared from the frame being processed,
wherein the interpolation signal generating unit generates the interpolation signal based on a signal in a zone immediately after the similar zone among the thinned signals stored in the thinned signal storing unit.

4. The decoding apparatus according to claim 3,
wherein the interpolation signal generating unit upsamples the signal in the zone immediately after the similar zone among the thinned signals stored in the thinned signal storing unit, and
the decoding apparatus further comprises a smoothing unit configured to perform a filtering process using a low-pass filter on the signal upsampled by the interpolation signal generating unit, and sets the filtered signal as the interpolation signal.

5. The decoding apparatus according to claim 4, wherein the smoothing unit uses one of the audio signal immediately before the audio signal having disappeared from the frame being processed, and the signal obtained by upsampling the thinned signal of the time immediately before the audio signal having disappeared, as an initial value of an internal state of the low-pass filter.

6. The decoding apparatus according to claim 5, wherein the thinning unit generates the thinned signal by performing the thinning process on one of the decoded signal and the interpolation signal, which is output as the output signal from the output switching unit.

7. The decoding apparatus according to claim 6, further comprising an interpolation state determining unit configured to determine an interpolation status based on the error information about the frame,
wherein the output switching unit generates a combined signal by performing a weighted overlap addition on the interpolation signal and the decoded signal, and outputs one of the decoded signal, the interpolation signal, and the combined signal as the output signal in accordance with the interpolation status.

8. A decoding method including the steps of:
generating a decoded signal by decoding an audio signal on a frame basis; generating a thinned signal by performing a thinning process on an output signal that is output earlier;
generating an interpolation signal based on the thinned signal; and
outputting the decoded signal or the interpolation signal as the output signal in accordance with error information about the frame.

9. A program for causing a computer to perform a process including the steps of:
generating a decoded signal by decoding an audio signal on a frame basis;
generating a thinned signal by performing a thinning process on an output signal that is output earlier;
generating an interpolation signal based on the thinned signal; and
outputting the decoded signal or the interpolation signal as the output signal in accordance with error information about the frame.

10. An audio signal processing apparatus comprising:
a timing signal generating unit configured to output an internal timing signal when a double buffer is switched while an audio signal is processed by using the double buffer formed with two buffers each having a predetermined length; and
a synchronization control unit configured to synchronize the internal timing signal with an external timing signal supplied from the outside when the internal timing signal and the external timing signal are not in synchronization, by shortening a duration of time before the switching in the double buffer by an amount equivalent to a phase difference between the internal timing signal and the external timing signal.

11. The audio signal processing apparatus according to claim 10, further comprising a state changing unit configured to change a current state to a synchronization complete state and continue the processing of the audio signal using the double buffer when the internal timing signal and the external timing signal are in synchronization, and change the current state to a synchronization incomplete state and suspend the processing of the audio signal when the internal timing signal and the external timing signal are not in synchronization.

12. The audio signal processing apparatus according to claim 11, wherein, when processing of audio signals of a plurality of channels is controlled and there is a request for a change of the number of channels of the audio signals to be processed, the state changing unit changes the current state to the synchronization incomplete state, and suspends the processing of the audio signal.

13. The audio signal processing apparatus according to claim 12, wherein the synchronization control unit synchronizes the internal timing signal with the external timing signal by shortening a length of one buffer in the double buffer by the amount equivalent to the phase difference and shortening the duration of time before the switching in the double buffer, and returns the duration of time before the next switching in the double buffer to the original unshortened length by returning the shortened length of the buffer to the original length.

14. The audio signal processing apparatus according to claim 13,
wherein the timing signal generating unit switches the double buffer and outputs the internal timing signal when the audio signal received is stored into one of the buffers constituting the double buffer and the storing of the audio signal into the one of the buffers is completed,
the state changing unit controls encoding of the audio signal depending on whether the current state is the synchronization complete state or is the synchronization incomplete state, and
the audio signal processing apparatus further comprises an encoding unit configured to encode the audio signal stored in the other one of the buffers constituting the double buffer when the current state is the synchronization complete state.

15. The audio signal processing apparatus according to claim 13,
wherein the timing signal generating unit switches the double buffer and outputs the internal timing signal when the audio signal decoded and stored in one of the buffers constituting the double buffer is transmitted and the transmission of the audio signal from the one of the buffers is completed,
the state changing unit controls decoding of the audio signal depending on whether the current state is the synchronization complete state or is the synchronization incomplete state, and
the audio signal processing apparatus further comprises a decoding unit configured to decode the audio signal and stores the decoded audio signal into the other one of the buffers constituting the double buffer when the current state is the synchronization complete state.

16. The audio signal processing apparatus according to claim 12,
wherein a recording region of a size determined by the largest possible number of channels of the audio signal to be processed is secured as a static data storage region for storing information necessary for processing the audio signal of each channel, and
static data regions of the respective channels for storing the information necessary for processing the audio signal are secured in the static data storage region when there is a request for a change of the number of channels.

17. An audio signal processing method comprising the steps of:
outputting an internal timing signal when a double buffer is switched while an audio signal is processed by using the double buffer formed with two buffers each having a predetermined length; and
synchronizing the internal timing signal with an external timing signal supplied from the outside when the internal timing signal and the external timing signal are not in synchronization, by shortening a duration of time before the switching in the double buffer by an amount equivalent to a phase difference between the internal timing signal and the external timing signal.

18. A program for causing a computer to perform a process comprising the steps of:
outputting an internal timing signal when a double buffer is switched while an audio signal is processed by using the double buffer formed with two buffers each having a predetermined length; and
synchronizing the internal timing signal with an external timing signal supplied from the outside when the internal timing signal and the external timing signal are not in synchronization, by shortening a duration of time before the switching in the double buffer by an amount equivalent to a phase difference between the internal timing signal and the external timing signal.
